(19) United States
(12) Patent Application Publication
(10) Pub. No.: US 2026/0357954 A1
(43) Pub. Date: Nov. 12, 2026

(54) TOILET SYSTEM, RADIO-FREQUENCY DEVICE FOR TOILET APPARATUS, AND METHOD FOR DETECTING STATE OF TOILET SYSTEM

(71) Applicant: TOTO LTD., Kitakyushu-shi, Fukuoka (JP)

(72) Inventors: Mao Jinde, Fukuoka (JP); Hiroshi Tsuboi, Fukuoka (JP); Katsunori Ishii, Fukuoka (JP); Satoko Kizuka, Fukuoka (JP); Takashi Bando, Fukuoka (JP)

(21) Appl. No.: 19/515,847

(22) PCT Filed: Jun. 10, 2024
(86) PCT No.: PCT/JP2024/021081

§ 371 Date: Mar. 3, 2026

(30) Foreign Application Priority Data
Nov. 30, 2023 (JP) 2023-202390

(51) Int. Cl. F17D 3/01; E03D 9/00

(52) U.S. Cl. CPC F17D 3/01; E03D 9/00; E03D 2201/00

(57) ABSTRACT

A toilet system according to an embodiment includes a bowl portion that receives excreta, a trap portion that forms sealing water on a bottom side of the bowl portion, a radio-frequency sensor that detects a state change occurring in sealing water on the trap portion side due to the excreta falling into the sealing water, and estimation means that estimates urine or feces information relating to the excreta based on a detection result obtained by the radio-frequency sensor.

### TECHNICAL FIELD

Embodiments of the present disclosure relate to a toilet system, a radio-frequency device for a toilet apparatus, and a method for detecting a state of a toilet system.

### BACKGROUND ART

In the related art, there has been proposed a technique for acquiring various types of information regarding a user who uses a toilet. There is known a technique for calculating a urine amount based on image information captured by an imaging unit (camera) that is disposed inside a toilet drain passage in order to capture an image of water overflowing from a sealing water portion (also referred to as “overflow water”) (see, for example, PTL 1).

### CITATION LIST

### Patent Literature

PTL 1: Japanese Unexamined Patent Application Publication No. 2018-109285

### SUMMARY OF INVENTION

### Technical Problem

However, there is room for improvement in the related art described above. For example, in the related art described above, it is necessary to dispose a camera inside a toilet drain passage, that is, a drainage pipe (also simply referred to as a “drain pipe”) in order to capture an image of overflow water, which results in a limitation on an arrangement of a sensor. In addition, in the related art described above, it is also required to, for example, prevent overflow water from coming into contact with the camera, and it is necessary to make the pipe longer in a horizontal direction in order to dispose the camera inside the pipe, which leads to a limitation on the structure of the pipe. In this manner, the related art described above has many limitations for appropriately detecting a state change that occurs in a toilet, and there is room for improvement in the related art.

An object of embodiments of the disclosure is to provide a toilet system, a radio-frequency device for a toilet apparatus, and a method for detecting a state of a toilet system capable of appropriately detecting a state change that occurs in a toilet.

### Solution to Problem

A toilet system according to one aspect of an embodiment includes: a bowl portion that receives excreta; a trap portion that forms sealing water on a bottom side of the bowl portion; a radio-frequency sensor that detects a state change occurring in sealing water on the trap portion side due to the excreta falling into the sealing water; and estimation means that estimates urine or feces information relating to the excreta based on a detection result obtained by the radio-frequency sensor.

According to the toilet system according to one aspect of the embodiment, the toilet system can appropriately detect a state change occurring in a toilet by using the radio-frequency sensor that detects a state change occurring in sealing water on the trap portion side due to excreta falling into the sealing water. For example, the toilet system detects, with a radio-frequency sensor such as a microwave sensor or a millimeter-wave sensor, behavior of overflow water associated with a state change of the sealing water such as shaking of the sealing water on the trap portion side, thereby detecting, on the trap portion side, a state change of the sealing water-such as shaking of the sealing water-caused by a falling object (feces or urine) falling into the sealing water on the bowl portion side, so that urine or feces information can be easily acquired without disposing the sensor in a drain pipe. In addition, the toilet system can estimate urine or feces information relating to excreta by detecting the state change of the sealing water occurring on the trap portion side with the radio-frequency sensor.

In the toilet system according to one aspect of the embodiment, a detection range of the radio-frequency sensor is set to a region including an apex portion of the trap portion.

According to the toilet system according to one aspect of the embodiment, by setting the detection range of the radio-frequency sensor to the region including the apex portion of the trap portion, water (overflow water) overflowing over the trap portion can be detected, and thus, a state change occurring in a toilet can be appropriately detected.

In the toilet system according to one aspect of the embodiment, the radio-frequency sensor detects a state change of the sealing water based on overflow water from an apex portion of the trap portion.

According to the toilet system according to one aspect of the embodiment, by detecting a state change of sealing water based on overflow water from the apex portion of the trap portion, water (overflow water) overflowing over the trap portion can be detected, and thus, a state change occurring in a toilet can be appropriately detected.

In the toilet system according to one aspect of the embodiment, the estimation means estimates a urine flow rate or a feces amount based on a state change of the sealing water.

According to the toilet system according to one aspect of the embodiment, by estimating a urine flow rate or a feces amount based on a state change of the sealing water, information relating to excreta, such as a urine flow rate or a feces amount, can be appropriately estimated based on a state change occurring in a toilet.

In the toilet system according to one aspect of the embodiment, the estimation means estimates a urine flow rate based on information regarding a standing wave that is output from the radio-frequency sensor.

According to the toilet system according to one aspect of the embodiment, by estimating a urine flow rate based on information regarding a standing wave that is output from the radio-frequency sensor, information relating to excreta can be appropriately estimated based on a state change occurring in a toilet.

In the toilet system according to one aspect of the embodiment, the radio-frequency sensor is a millimeter-wave sensor or a microwave sensor.

According to the toilet system according to one aspect of the embodiment, by using a millimeter-wave sensor or a microwave sensor as the radio-frequency sensor, a state change occurring in a toilet can be appropriately detected.

In the toilet system according to one aspect of the embodiment, a drainage passage from the bowl portion extends between the radio-frequency sensor and an apex portion of the trap portion, and the radio-frequency sensor detects a state change of the sealing water based on overflow water from an apex portion of the trap portion.

According to the toilet system according to one aspect of the embodiment, the drainage passage from the bowl portion extends between the radio-frequency sensor and the apex portion of the trap portion, and the radio-frequency sensor detects a state change of the sealing water based on overflow water from the apex portion of the trap portion, and thus, water (overflow water) overflowing between the radio-frequency sensor and the trap portion can be detected, so that a state change occurring in a toilet can be appropriately detected.

A toilet system according to one aspect of an embodiment further includes a toilet seat device installed on an upper portion of a toilet main body including the bowl portion, and the radio-frequency sensor is provided at the toilet seat device.

According to the toilet system according to one aspect of the embodiment, by providing the radio-frequency sensor at the toilet seat device installed on the upper portion of the toilet main body including the bowl portion, a state change occurring in a toilet can be appropriately detected by the radio-frequency sensor provided at the toilet seat device.

In the toilet system according to one aspect of the embodiment, an antenna portion that is included in the radio-frequency sensor is disposed on a bottom portion side of the toilet seat device.

According to the toilet system according to one aspect of the embodiment, by disposing the antenna portion of the radio-frequency sensor on the bottom side of the toilet seat device, the antenna portion of the radio-frequency sensor that transmits and receives radio waves can be disposed near the apex portion of the trap portion, and thus, a state change occurring in a toilet can be appropriately detected.

In the toilet system according to one aspect of the embodiment, an antenna portion that is included in the radio-frequency sensor is provided at an outer wall of a drain pipe including the trap portion.

According to the toilet system according to one aspect of the embodiment, by providing the antenna portion of the radio-frequency sensor at the outer wall of the drain pipe including the trap portion, contact of the antenna portion of the radio-frequency sensor with drainage water flowing in the drain pipe can be suppressed, and thus, a state change occurring in a toilet can be appropriately detected.

In the toilet system according to one aspect of the embodiment, an antenna portion that is included in the radio-frequency sensor is disposed above the trap portion in a vertical direction.

According to the toilet system according to one aspect of the embodiment, by disposing the antenna portion of the radio-frequency sensor above the trap portion in the vertical direction, the antenna portion of the radio-frequency sensor that transmits and receives radio waves can be disposed near the apex portion of the trap portion, and thus, a state change occurring in a toilet can be appropriately detected.

In the toilet system according to one aspect of the embodiment, an antenna portion that is included in the radio-frequency sensor is disposed above sealing water on the trap portion side in a vertical direction.

According to the toilet system according to one aspect of the embodiment, by disposing the antenna portion of the radio-frequency sensor above the sealing water on the trap portion side in the vertical direction, the antenna portion of the radio-frequency sensor that transmits and receives radio waves can be disposed near the apex portion of the trap portion, and thus, a state change occurring in a toilet can be appropriately detected.

A toilet system according to one aspect of an embodiment further includes an optical sensor that detects a state change of the sealing water from the bowl portion side at a plurality of timings, and the estimation means estimates the urine or feces information based on a detection result obtained by the radio-frequency sensor and a detection result obtained by the optical sensor.

According to the toilet system according to one aspect of the embodiment, by estimating the urine or feces information using also a detection result obtained by the optical sensor that detects a state change of the sealing water from the bowl portion side at a plurality of timings, information relating to excreta can be more appropriately estimated.

In the toilet system according to one aspect of the embodiment, the estimation means estimates the urine or feces information when there is a correlation between a detection result obtained by the radio-frequency sensor and a detection result obtained by the optical sensor.

According to the toilet system according to one aspect of the embodiment, by estimating the urine or feces information when there is a correlation between a detection result obtained by the radio-frequency sensor and a detection result obtained by the optical sensor, information relating to excreta can be more appropriately estimated.

A toilet system according to one aspect of an embodiment further includes an optical sensor that detects feces before the feces enter the sealing water from the bowl portion side, and the estimation means acquires the urine or feces information based on a detection result obtained by the radio-frequency sensor and a detection result obtained by the optical sensor.

According to the toilet system according to one aspect of the embodiment, by acquiring the urine or feces information using also a detection result obtained by the optical sensor that detects feces before the feces enter the sealing water from the bowl portion side, information relating to excreta can be more appropriately estimated.

In the toilet system according to one aspect of the embodiment, the estimation means acquires feces information based on a detection result obtained by the optical sensor, and acquires the urine or feces information based on a detection result obtained by the radio-frequency sensor.

According to the toilet system according to one aspect of the embodiment, by acquiring feces information based on a detection result obtained by the optical sensor and acquiring the urine or feces information based on a detection result obtained by the radio-frequency sensor, information relating to excreta can be more appropriately estimated.

A radio-frequency device for a toilet apparatus according to one aspect of an embodiment is a radio-frequency device for a toilet apparatus that is installed at a toilet apparatus, and includes a radio-frequency sensor that detects a state change occurring in sealing water on a side of a trap portion that forms sealing water on a bottom side of a bowl portion included in the toilet apparatus, the state change being caused by excreta falling into sealing water in the bowl portion.

According to the radio-frequency device for a toilet apparatus according to one aspect of the embodiment, by using the radio-frequency sensor that detects a state change occurring in sealing water on the trap portion side due to excreta falling into sealing water, a state change occurring in a toilet can be appropriately detected. For example, the radio-frequency device for a toilet apparatus detects, with a radio-frequency sensor such as a microwave sensor or a millimeter-wave sensor, behavior of overflow water associated with a state change of the sealing water such as shaking of the sealing water on the trap portion side, thereby detecting, on the trap portion side, a state change of the sealing water such as shaking of the sealing water caused by a falling object (feces or urine) falling into the sealing water on the bowl portion side, so that urine or feces information can be easily acquired without disposing the sensor in a drain pipe.

A method for detecting a state of a toilet system according to one aspect of an embodiment includes a detection step of detecting a state change occurring in sealing water formed on a bottom side of a bowl portion included in the toilet system by a trap portion provided on a downstream side of the bowl portion in a drainage direction, the state change occurring in sealing water on the trap portion side due to excreta falling into sealing water on the bowl portion side.

According to the method for detecting a state of a toilet system according to one aspect of the embodiment, by using the radio-frequency sensor that detects a state change occurring in sealing water on the trap portion side due to excreta falling into sealing water, a state change occurring in a toilet can be appropriately detected. For example, the method for detecting a state of a toilet system detects, with a radio-frequency sensor such as a microwave sensor or a millimeter-wave sensor, behavior of overflow water associated with a state change of the sealing water such as shaking of the sealing water on the trap portion side, thereby detecting, on the trap portion side, a state change of the sealing water such as shaking of the sealing water caused by a falling object (feces or urine) falling into the sealing water on the bowl portion side, so that urine or feces information can be easily acquired without disposing the sensor in a drain pipe.

### Advantageous Effects of Invention

According to an aspect of an embodiment, a state change occurring in a toilet can be appropriately detected.

### BRIEF DESCRIPTION OF DRAWINGS

FIG. 1 is a perspective view illustrating an example of a configuration of a toilet system according to an embodiment.

FIG. 2 is a perspective view illustrating an example of a configuration of a toilet seat device according to an embodiment.

FIG. 3 is a perspective view illustrating an example of a configuration of a toilet seat device according to an embodiment.

FIG. 4 is a schematic view illustrating an example of a configuration of a toilet apparatus according to an embodiment.

FIG. 5 is a block diagram illustrating an example of a configuration of a toilet seat device and a radio-frequency sensor according to an embodiment.

FIG. 6 is a block diagram illustrating an example of a configuration of a control device according to an embodiment.

FIG. 7 is a diagram illustrating an overview of processing for estimating information regarding excreta.

FIG. 8 is a diagram illustrating an example of a relationship between a flow rate and a height of overflow water.

FIG. 9 is a diagram illustrating an example of a state change accompanying a flow rate change.

FIG. 10 is a diagram illustrating an example of detection information obtained by a microwave sensor.

FIG. 11 is a diagram illustrating an example of a relationship between wavelengths.

FIG. 12 is a diagram illustrating an example of characteristics of a radio-frequency sensor.

FIG. 13 is a diagram illustrating an example of a method for detecting a water level change.

FIG. 14 is a diagram illustrating an example of processing for calculating a flow rate from a water level change.

FIG. 15 is a diagram illustrating an example of a method for calculating a flow rate.

FIG. 16 is a diagram illustrating an example of a method for calculating a flow rate.

FIG. 17 is a diagram illustrating an example of a relationship between an area and a total urine amount.

FIG. 18 is a diagram illustrating an example of processing when defecation occurs during urination.

FIG. 19 is a diagram illustrating an example of processing when defecation occurs during urination.

FIG. 20 is a diagram illustrating an example of calculation using two outputs.

FIG. 21 is a diagram illustrating an example of a configuration of a radio-frequency sensor.

FIG. 22 is a diagram illustrating an example of processing using a relationship between two outputs.

### DESCRIPTION OF EMBODIMENTS

Embodiments of a toilet system disclosed in the present application will be described in detail below with reference to the accompanying drawings. Note that the present invention is not limited to the embodiment described below. In the following description, processing relating to estimation of information regarding excreta of a user, such as a urine amount, that is performed by a toilet system 1 and a configuration for performing the processing will be described. First, various components of a toilet system and the like that serve as a basis will be described.

### 1. Configuration of Toilet System

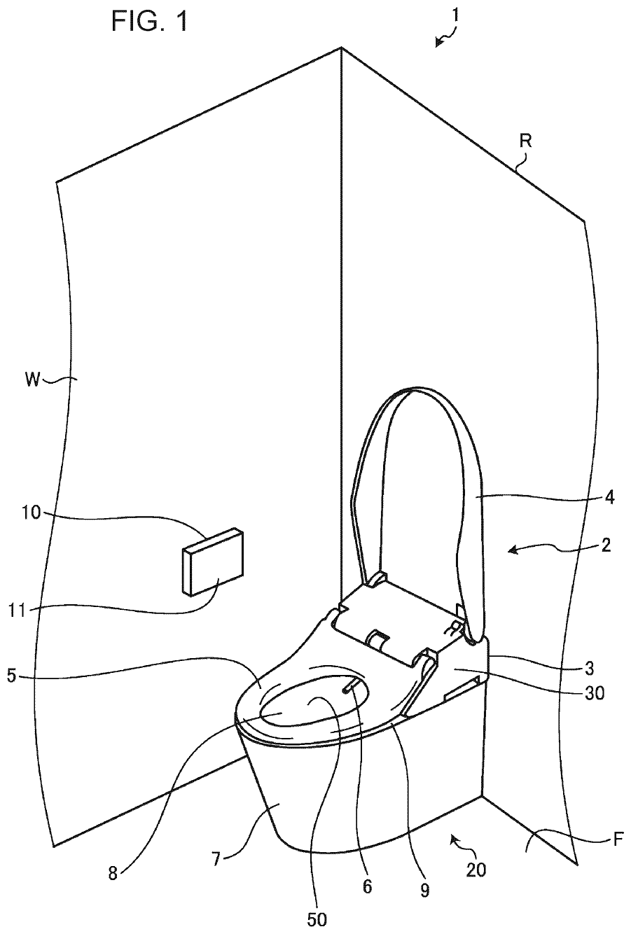

First, the configuration of a toilet system according to an embodiment will be described below with reference to FIG. 1. FIG. 1 is a perspective view illustrating an example of the configuration of the toilet system 1 according to an embodiment.

As illustrated in FIG. 1, the toilet system 1 includes a toilet apparatus 20 and an operation device 10. As illustrated in FIG. 1, in a toilet room R, a toilet 7 is installed on a floor surface F, and a toilet seat device 2 that is installed on an upper portion of the toilet 7 is installed. Note that, in the following description, a direction from the floor surface F toward a space in the toilet room R will be referred to as “upward”.

The toilet 7 is a so-called flush toilet (Western-style flush toilet), and, for example, a material that is a ceramic or a resin is used. The toilet 7 includes a bowl portion 8. The bowl portion 8 has a downwardly recessed shape and is a portion that receives excreta of a user. As described above, the toilet 7 functions as a toilet main body that includes the bowl portion 8. Note that a bottom surface of the bowl portion 8 communicates with a drain pipe 81. This matter will be described below.

In addition, the toilet 7 is not limited to being a floor-mounted type as illustrated, and may be of any type such as a wall-mounted type or the like as long as the toilet system 1 is applicable thereto. The toilet 7 includes a rim portion 9 that is provided over the entire circumference of an end portion of an opening facing the bowl portion 8. In the toilet room R, for example, a flush water tank that stores flush water may be installed near the toilet 7, or a so-called tankless type in which a flush water tank is not installed may be employed.

For example, when a washing operation unit (not illustrated) for washing provided in the toilet room R is operated by a user, toilet flushing is performed by supplying flush water to the bowl portion 8 of the toilet 7. The washing operation unit may be an operation lever or a touch operation that is performed on a toilet flushing object displayed on the operation device 10. Note that the washing operation unit is not limited to one such as an operation lever that is manually operated by a user to cause toilet flushing to be performed, and may be one that causes toilet flushing to be performed in response to detection of a human body by a sensor such as a seating sensor that detects a user.

The toilet seat device 2 is attached to an upper portion of the toilet 7 and includes a main body portion 3, a toilet lid 4, a toilet seat 5, and a washing nozzle 6. The toilet seat device 2 is placed on the upper portion of the toilet 7 in which the bowl portion 8 that receives excreta is formed. The toilet seat device 2 is placed on the upper portion of the toilet 7 such that the washing nozzle 6 advances into the bowl portion 8 before ejecting washing water. Note that the toilet seat device 2 may be detachably attached to the toilet 7, or may be attached so as to be integrated with the toilet 7. In addition, for example, the main body portion 3 functions as a functional unit in which components for performing various functions (e.g., a control device 100 and the like) are arranged in a main body cover 30.

As illustrated in FIG. 1, the toilet seat 5 is formed in an annular shape that has an opening 50 at a center thereof, and is disposed at a position that overlaps with an opening of the toilet 7 along the rim portion 9. A user sits on the toilet seat 5. The toilet seat 5 functions as a seating portion that supports buttocks of the seated user. Furthermore, as illustrated in FIG. 1, the toilet lid 4 and the toilet seat 5 are attached such that respective one end portions of the toilet lid 4 and the toilet seat 5 are pivotally supported by the main body portion 3, and the toilet lid 4 and the toilet seat 5 are rotatable (openable and closable) around a pivotally supported portion of the main body portion 3. Note that the toilet lid 4 is attached to the toilet seat device 2 as necessary, and the toilet seat device 2 may not have the toilet lid 4.

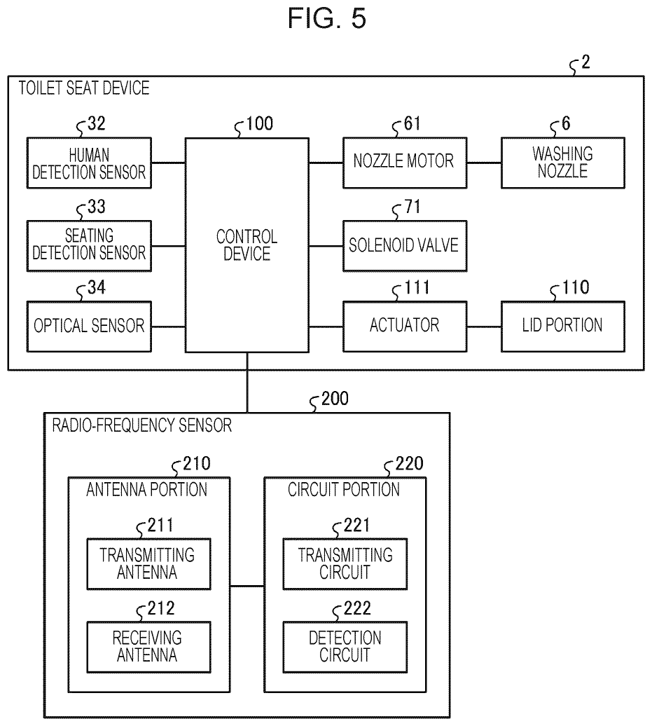

The washing nozzle 6 is a nozzle for ejecting washing water. The washing nozzle 6 is capable of ejecting washing water. The washing nozzle 6 is capable of ejecting washing water toward a user. The washing nozzle 6 is a nozzle for washing a private part. The washing nozzle 6 is configured to be capable of advancing and retracting with respect to the main body cover 30 that is a housing of the main body portion 3 as it is driven by a drive source such as an electric motor (a nozzle motor 61 or the like in FIG. 5). In addition, the washing nozzle 6 is connected to a water source such as a water pipe, which is not illustrated. As illustrated in FIG. 1, when the washing nozzle 6 is located at a position to which it has advanced with respect to the main body cover 30, which is the housing of the main body portion 3 (also referred to as “advanced position”), the washing nozzle 6 ejects water from the water source toward a user's body to wash the user's private part.

FIG. 1 illustrates a state in which the washing nozzle 6 is at the advanced position. Note that the washing nozzle 6 may also be shared for washing the inside of the toilet 7 (the bowl portion 8 and the like). The washing nozzle 6 may be used in a switchable manner between a private-part washing mode for washing a private part of a user and a toilet washing mode for spraying water into the toilet 7. For example, the washing nozzle 6 may be used in a switchable manner between the private-part washing mode and the toilet washing mode in response to control by the toilet seat device 2.

The operation device 10 is provided in the toilet room R. The operation device 10 is provided at a position at which it can be operated by a user. The operation device 10 is provided at a position at which it can be operated by a user when the user is seated on the toilet seat 5. In FIG. 1, the operation device 10 is disposed on the wall surface W that is located on the right side as viewed from a user seated on the toilet seat 5. Note that the operation device 10 is not limited to being on a wall surface and may be arranged in various manners as long as it can be used by a user seated on the toilet seat 5. For example, the operation device 10 may be provided integrally with the toilet seat device 2.

The operation device 10 is connected to the toilet seat device 2 via a predetermined network so as to be capable of communicating with each other by a wired or wireless connection. For example, the toilet seat device 2 and the operation device 10 may be connected to each other in any manner as long as they are capable of transmitting and receiving information to and from each other. The toilet seat device 2 and the operation device 10 may be connected so as to be capable of communicating with each other by a wired connection, or may be connected so as to be capable of communicating with each other by a wireless connection.

The operation device 10 receives various operations from a user via a display surface (e.g., a screen 11) using, for example, a touch panel function. In addition, the operation device 10 may include a switch, a button, or the like and may receive various operations via the switch, the button, or the like. The screen 11 is a screen of a tablet terminal or the like that is implemented by, for example, a liquid crystal display, an organic electro-luminescence (EL) display, or the like, and is a display device for displaying various types of information. In other words, the operation device 10 receives input from a user through the screen 11 and also performs output to the user. In this case, the operation device 10 identifies the user among users registered beforehand. Subsequently, the control unit 130 establishes an association between the user information and information regarding excreta, which will be described later, or information obtained based on the information regarding excreta and transmits the associated information to the terminal of the user. In this case, the control unit 130 may also transmit, to the terminal of the user, date-and-time information indicating when the information regarding excreta has been acquired. The screen 11 is a display device that displays various types of information.

The operation device 10 receives a user operation for stopping control being performed by the toilet seat device 2. The operation device 10 receives a user operation for starting execution of private-part washing by the toilet seat device 2. The operation device 10 receives an instruction from a user to the washing nozzle 6. The operation device 10 receives a user operation for causing the toilet seat device 2 to output a predetermined sound. The operation device 10 receives a user operation for performing a sterilization treatment for sterilizing the washing nozzle 6 (see FIG. 1) of the toilet seat device 2 with sterilizing water. The operation device 10 receives a user operation for adjusting the water discharge strength during private-part washing performed by the toilet seat device 2. The operation device 10 receives a user operation for adjusting the volume of sound output from the toilet seat device 2. The operation device 10 receives a user operation for selecting a language used when information regarding use of a toilet is displayed on the operation device 10 or output by voice.

For example, the operation device 10 may display, on the screen 11, an object that receives the above-mentioned user operation, and may perform various types of processing in response to a user coming into contact with the displayed object. For example, the operation device 10 may include a switch, a button, or the like mentioned above that receives a user operation, and may perform various types of processing in response to a user coming into contact with the switch, the button, or the like. Note that the above is an example, and the operation device 10 may receive an operation from a user for performing various types of processing.

### 2. Configuration of Toilet Apparatus

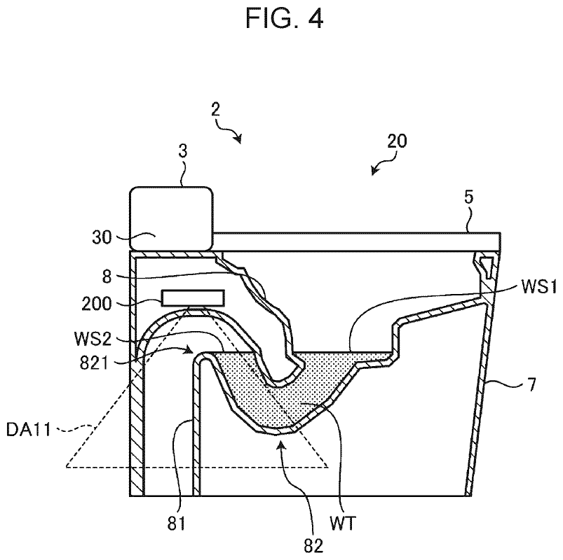

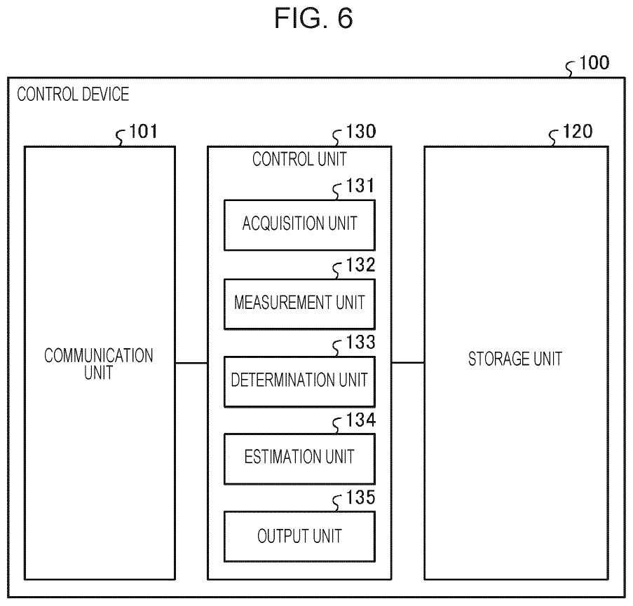

The configuration of the toilet apparatus 20 will be described below. The toilet apparatus 20 includes the toilet 7 including the bowl portion 8, a radio-frequency sensor 200 (see FIG. 4), and the control device 100 (see FIG. 6) that functions as estimation means. The toilet apparatus 20 detects, by the radio-frequency sensor 200, a state change occurring in sealing water due to excreta falling into the sealing water. In addition, the toilet apparatus 20 estimates urine or feces information relating to excreta based on a detection result obtained by the radio-frequency sensor 200, and this matter will be described later. The toilet system 1 may provide information to a terminal device of a user, such as a smartphone, based on the estimated information. In addition, the toilet system 1 may provide information to the operation device 10 (or the screen 11) in the toilet room R based on the estimated information.

### 2-1. Configuration of Toilet Seat Device

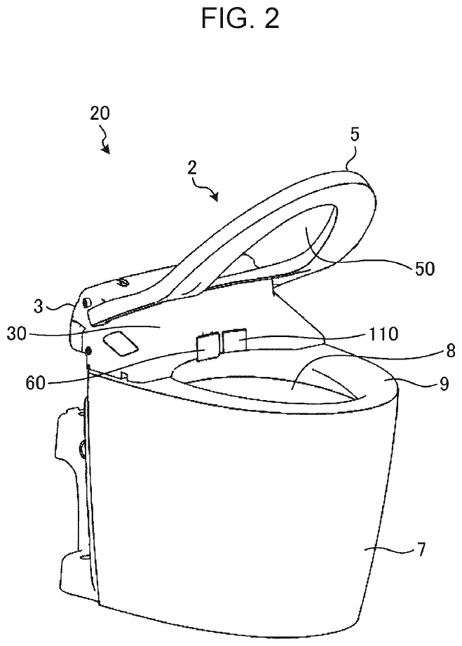

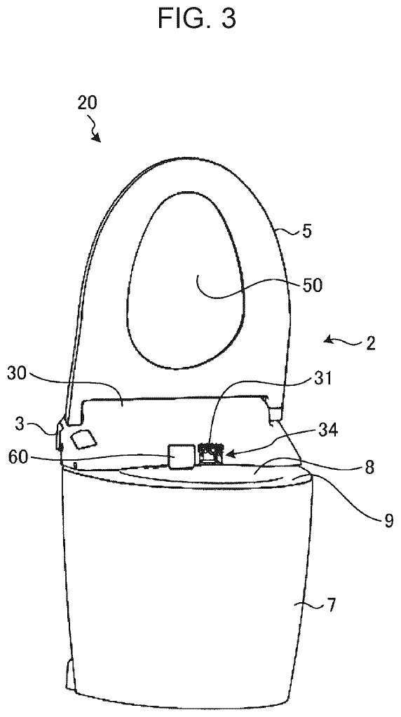

In FIG. 1, the toilet apparatus 20 includes the toilet seat device 2 that is installed on an upper portion of the toilet 7. The configuration of the toilet seat device 2 will be described below with reference to FIGS. 2 and 3.

FIGS. 2 and 3 are perspective views illustrating an example of the configuration of the toilet seat device according to the embodiment. Specifically, FIG. 2 illustrates the case where a lid portion 110 of the toilet seat device 2 is in a closed position (also referred to as a “closed state”). FIG. 3 illustrates a state in which the lid portion 110 of the toilet seat device 2 is removed.

As illustrated in FIG. 2, in the closed state of the lid portion 110, the optical sensor 34 is hidden behind the lid portion 110. In the closed state of the lid portion 110, the lid portion 110 is located in front of the optical sensor 34. In this manner, in the closed state, the lid portion 110 is located in front of the optical sensor 34.

In addition, FIG. 2 illustrates a state in which the washing nozzle 6 (see FIG. 1) is at a position at which the washing nozzle 6 is accommodated in the main body cover 30 (also referred to as “accommodated position”). As illustrated in FIG. 2, when the washing nozzle 6 is at the accommodated position, a nozzle cover 60 is closed, and the washing nozzle 6 is hidden behind the nozzle cover 60. When washing is performed by the washing nozzle 6, the nozzle cover 60 is opened, and the washing nozzle 6 projects from an opening that is formed for the washing nozzle 6 in the main body cover 30, thereby transitioning to an advanced state.

As illustrated in FIG. 3, when the lid portion 110 is removed, the optical sensor 34 is exposed through an opening 31 of the main body cover 30. For example, when the lid portion 110 is in an open position (also referred to as an “open state”), as illustrated in FIG. 3, the lid portion 110 is not located in front of the optical sensor 34. Thus, in the open state of the lid portion 110, the optical sensor 34 is exposed. In the open state of the lid portion 110, the optical sensor 34 is capable of detecting a state change of sealing water in the toilet 7. Note that the toilet seat device 2 does not necessarily include the lid portion 110. In this case, the toilet seat device 2 does not include either the lid portion 110 or an actuator 111, and the optical sensor 34 may be always exposed.

### 2-2. Configuration of Drain Pipe and Arrangement of

Radio-Frequency Sensor in Toilet Apparatus>Next, an example of the configuration of a drain pipe in the toilet apparatus and an arrangement of a radio-frequency sensor will be described with reference to FIG. 4. FIG. 4 is a schematic view illustrating an example of the configuration of the toilet apparatus according to the embodiment. Specifically, FIG. 4 is a schematic side cross-sectional view when the toilet 7 is viewed from the side, and FIG. 4 illustrates only principal portions including the toilet 7 among components of the toilet apparatus 20 in cross section in order to illustrate the configuration of the drain pipe 81 and the arrangement of the radio-frequency sensor 200. Note that the cross-sectional shape of the toilet 7 in FIG. 4 is merely an example. As long as the radio-frequency sensor 200 can be disposed at a desired position, a hollow portion of the toilet 7 may have any configuration, and, for example, only a portion of the toilet 7 in which the radio-frequency sensor 200 is disposed may be a hollow portion.

An opening that is formed in a bottom portion of the bowl portion 8 of the toilet 7 communicates with the drain pipe 81. The drain pipe 81 is a drainage pipe extending from the bowl portion 8, and an internal space of the drain pipe 81 functions as a drainage passage. In FIG. 4, the drain pipe 81 has a shape in which the drain pipe 81 extends obliquely downward from an end portion of the drain pipe 81 connected to a bottom portion of the bowl portion 8, then extends obliquely upward to form a U-shape (V-shape), and then extends downward. As a result, a trap portion 82 is formed in the drain pipe 81. The trap portion 82 forms sealing water WT that extends to the bottom side of the bowl portion 8. Note that the configuration of the drain pipe 81 illustrated in FIG. 4 is merely an example, and any configuration may be employed for the drain pipe 81 as long as it can form a trap that enables processing that will be described later to be performed.

In FIG. 4, in the toilet 7, a hatched portion in the bowl portion 8 and a hatched portion in the drain pipe 81 are filled with the sealing water WT (water). In addition, in FIG. 4, a sealing water surface WS1 represents an upper surface defined by the sealing water WT on the bottom side of the bowl portion 8, and a sealing water surface WS2 represents an upper surface defined by the sealing water WT on the trap portion 82 side.

In FIG. 4, in the drain pipe 81, an apex portion 821 is formed at an end portion of the trap portion 82 that is located on the side opposite to the end portion connected to the bottom portion of the bowl portion 8. A detection range DA11 of the radio-frequency sensor 200 is set to a region including the apex portion 821 of the trap portion 82. For example, the radio-frequency sensor 200 is disposed such that the detection range DA11 includes the apex portion 821 of the trap portion 82. Note that a range illustrated in FIG. 4 is merely an example of the detection range DA11 of the radio-frequency sensor 200, and the detection range DA11 of the radio-frequency sensor 200 is not limited to the range illustrated in FIG. 4 and may be any range as long as the detection range DA11 includes the apex portion 821 of the trap portion 82.

For example, the radio-frequency sensor 200 is a microwave sensor. A case in which the radio-frequency sensor 200 is a microwave sensor will be described as an example below. However, the radio-frequency sensor 200 is not limited to a microwave sensor. For example, any sensor such as a millimeter-wave sensor can be employed as the radio-frequency sensor 200 as long as desired detection can be performed.

Any arrangement can be employed as long as the radio-frequency sensor 200 is disposed such that the detection range DA11 includes the apex portion 821 of the trap portion 82. For example, the radio-frequency sensor 200 is disposed above the trap portion 82 in the vertical direction. For example, the radio-frequency sensor 200 is disposed above the sealing water on the trap portion 82 side (e.g., the sealing water surface WS2) in the vertical direction. For example, the radio-frequency sensor 200 is provided along an outer wall of the drain pipe 81 including the trap portion 82. In FIG. 4, the radio-frequency sensor 200 is provided outside the drain pipe 81 and is disposed above the trap portion 82. In this case, the drainage passage from the bowl portion 8 extends between the radio-frequency sensor 200 and the apex portion 821 of the trap portion 82. As a result, the drainage passage from the bowl portion 8 of the toilet 7 extends between an antenna portion 210 (see FIG. 5) that is included in the radio-frequency sensor 200 and the apex portion 821 of the trap portion 82.

Note that the arrangement described above is merely an example, and various arrangements may be employed for the radio-frequency sensor 200. For example, the radio-frequency sensor 200 may be provided at the toilet seat device 2. When the radio-frequency sensor 200 is provided at the toilet seat device 2, the radio-frequency sensor 200 may be disposed on a bottom side (lower side) of the toilet seat device 2. In this case, the antenna portion 210 of the radio-frequency sensor 200 is disposed at the bottom portion of the toilet seat device 2 on the toilet 7 side. For example, the radio-frequency sensor 200 may be disposed in the main body portion 3, which is a functional unit. For example, the radio-frequency sensor 200 may be disposed in the main body cover 30. A configuration in which the radio-frequency sensor 200 is disposed above the trap portion 82 as illustrated in FIG. 4 will be described as an example below.

With the above-described arrangement, the radio-frequency sensor 200 detects a state change occurring in the sealing water on the trap portion 82 side. The radio-frequency sensor 200 detects a change in the state of the sealing water, including overflow water from the apex portion 821 of the trap portion 82. For example, the radio-frequency sensor 200 detects a state change occurring in the sealing water on the trap portion 82 side due to excreta falling into the sealing water on the bowl portion 8 side. For example, the radio-frequency sensor 200 detects a state change of the sealing water based on overflow water from the apex portion 821 of the trap portion 82, and this matter will be described later.

Note that the radio-frequency sensor 200 may be separate from the toilet apparatus 20 and may be attachable to and detachable from the toilet apparatus 20. In this case, for example, the radio-frequency sensor 200 may be a radio-frequency device for a toilet apparatus that is installed at the toilet apparatus 20. The radio-frequency sensor 200 detects a state change occurring in the sealing water on the trap portion 82 side, the trap portion 82 forming the sealing water on the bottom side of the bowl portion 8, due to excreta falling into the sealing water in the bowl portion 8 included in the toilet apparatus 20.

### 3. Configuration of Toilet Seat Device and Configuration of Radio-Frequency Sensor

Next, the configuration of the toilet seat device 2 and the configuration of the radio-frequency sensor 200 will be described with reference to FIG. 5. FIG. 5 is a block diagram illustrating an example of the configuration of the toilet seat device and the configuration of the radio-frequency sensor according to the embodiment.

### 3-1. Functional Configuration of Toilet Seat Device

First, the functional configuration of the toilet seat device 2 will be described. As illustrated in FIG. 5, the toilet seat device 2 includes a human detection sensor 32, a seating detection sensor 33, an optical sensor 34, the control device 100, a nozzle motor 61, the washing nozzle 6, a solenoid valve 71, the lid portion 110, and the actuator 111. Note that, in FIG. 5, some of the components of the toilet seat device 2 (such as the main body portion 3, the toilet seat 5, and the toilet 7), which have been described with reference to FIG. 1, are not illustrated.

In addition, the configuration of the toilet seat device 2 illustrated in FIG. 5 is merely an example, and any configuration can be employed for the toilet seat device 2. The human detection sensor 32, the seating detection sensor 33, the optical sensor 34, the control device 100, and the like are arranged at any location. For example, the optical sensor 34 is provided at the main body portion 3 of the toilet seat device 2. By using a communication device (e. g., a communication unit 101 of the control device 100 in FIG. 6, or the like), the toilet seat device 2 transmits and receives information to and from an information processing device such as the operation device 10 via a predetermined network (such as the Internet) in a wired or wireless manner.

The human detection sensor 32 has a function of detecting a human body. For example, the human detection sensor 32 is implemented by a pyroelectric sensor or the like that uses an infrared signal. For example, the human detection sensor 32 may be implemented by a microwave (u-wave) sensor or the like. Note that the above is merely an example, and the human detection sensor 32 is not limited to the above and may detect a human body by various means. For example, the human detection sensor 32 detects a person (such as a user) who has entered the toilet room R (see FIG. 1). The human detection sensor 32 outputs a detection signal to the control device 100.

The seating detection sensor 33 has a function of detecting a person seated on the toilet seat device 2. The seating detection sensor 33 detects that a user is seated on the toilet seat 5. The seating detection sensor 33 is capable of detecting a user seated on the toilet seat 5. The seating detection sensor 33 also functions as an unseating detection sensor that detects unseating of a user from the toilet seat 5. The seating detection sensor 33 detects a seated state of a user on the toilet seat 5.

For example, the seating detection sensor 33 detects, by a load sensor, that a user is seated on the toilet seat 5. For example, the seating detection sensor 33 is an infrared light-emitting and light-receiving distance-measuring sensor and may detect a human body present in the vicinity of the toilet seat 5 immediately before a person (user) sits on the toilet seat 5, or a user seated on the toilet seat 5. Note that the above is merely an example, and the seating detection sensor 33 is not limited to the above and may detect, by various means, a person seated on the toilet seat device 2. The seating detection sensor 33 outputs a seating detection signal to the control device 100.

The optical sensor 34 is a sensor that detects a state change relating to the toilet apparatus 20. The optical sensor 34 detects a state change of the sealing water in the toilet 7. For example, the optical sensor 34 detects a state change on the bowl portion 8 side. The optical sensor 34 detects the state change of the sealing water from the bowl portion 8 side at a plurality of timings. For example, the detection range of the optical sensor 34 includes the sealing water on the bowl portion 8 side (e.g., the sealing water surface WS1 or the like). Note that the detection manner described above is merely an example, and the optical sensor 34 may perform any detection as long as desired detection can be performed.

For example, the optical sensor 34 may detect feces before the feces enter the sealing water from the bowl portion 8 side. The optical sensor 34 detects feces falling in the bowl portion 8 (falling feces). In this case, the detection range of the optical sensor 34 includes the inside of the bowl portion 8.

Any configuration may be employed for the optical sensor 34 as long as the optical sensor 34 can detect a desired state change. For example, the optical sensor 34 is disposed at a position that corresponds to a detection manner of the optical sensor 34, depending on what type of sensor is used as the optical sensor 34. The optical sensor 34 may be a non-contact sensor. For example, FIG. 4 illustrates a case where the optical sensor 34 is a non-contact sensor. In this case, the optical sensor 34 may be a camera, a line sensor, an ultrasonic sensor, an infrared sensor, or the like. Alternatively, the optical sensor 34 may be a contact sensor. In this case, the optical sensor 34 may be a float sensor, a pressure sensor, or the like. Note that the above is merely an example, and any sensor may be used as the optical sensor 34 as long as a desired state change can be detected.

In addition, in a case where the optical sensor 34 detects the presence or absence of defecation, imaging means such as a camera or a line sensor may be used as the optical sensor 34. In this case, for example, the optical sensor 34 is a line sensor that is disposed so as to face the inside of the bowl portion 8, and the optical sensor 34 may detect a falling object such as excreta falling in the bowl portion 8. Alternatively, the optical sensor 34 is a camera that is disposed so as to face the sealing water in the bowl portion 8, and the optical sensor 34 may detect a falling object such as excreta that has entered the sealing water.

The control device 100 controls various components and processing. The control device 100 is a computer (information processing apparatus) that executes various types of information processing such as estimation (calculation) of information relating to excreta, such as a urine flow rate (a urine amount) or a feces amount. The control device 100 functions as estimation means that estimates information regarding urine or feces relating to excreta based on a detection result obtained by the radio-frequency sensor 200.

The control device 100 estimates a urine flow rate or a feces amount based on a state change of the sealing water. For example, the control device 100 estimates a urine flow rate based on information regarding a standing wave output from the radio-frequency sensor 200. For example, the control device 100 estimates information regarding urine or feces based on detection results obtained by the radio-frequency sensor 200 and the optical sensor 34.

For example, the control device 100 estimates information regarding urine or feces in a case where there is a correlation between a detection result obtained by the radio-frequency sensor 200 and a detection result obtained by the optical sensor 34. For example, the control device 100 acquires information regarding urine or feces based on detection results obtained by the radio-frequency sensor 200 and the optical sensor 34. For example, the control device 100 acquires information regarding feces based on a detection result obtained by the optical sensor 34 and acquires information regarding urine or feces based on a detection result obtained by the radio-frequency sensor 200.

In addition, the control device 100 controls various components of the toilet system 1. The control device 100 controls the nozzle motor 61, the solenoid valve 71, and the actuator 111. The control device 100 controls the nozzle motor 61, the solenoid valve 71, and the actuator 111 based on signals transmitted from the operation device 10.

The control device 100 controls the nozzle motor 61 based on a signal indicating a control instruction relating to private-part washing transmitted from the operation device 10. The control device 100 controls the nozzle motor 61 so as to cause the washing nozzle 6 to advance and retract. The control device 100 controls opening and closing of the solenoid valve 71.

The control device 100 controls the actuator 111 so as to open and close the lid portion 110. The control device 100 transmits control information for bringing the lid portion 110 into the open state to the actuator 111. The control device 100 transmits control information for bringing the lid portion 110 into the closed state to the actuator 111. For example, the control device 100 controls the lid portion 110 such that the lid portion 110 is in the closed state before the toilet 7 is used by a user or during a period when detection by the optical sensor 34 is not being performed.

The control device 100 transmits control information to the nozzle motor 61, the solenoid valve 71, and the actuator 111 in a wired manner. Note that the control device 100 may transmit control information to the nozzle motor 61, the solenoid valve 71, and the actuator 111 in a wireless manner. For example, in a case where the control device 100 is configured as an apparatus separate from the toilet seat device 2, the control device 100 may transmit control information for the nozzle motor 61, the solenoid valve 71, and the actuator 111 to the toilet seat device 2 in a wireless manner. In this case, a control device included in the toilet seat device 2 may control the nozzle motor 61, the solenoid valve 71, and the actuator 111 based on control information received thereby.

The control device 100 controls opening and closing operations of the lid portion 110. The control device 100 opens the lid portion 110 when a user detected by the human detection sensor 32 or the seating detection sensor 33 starts use of the toilet 7, and the control device 100 closes the lid portion 110 when the user detected by the human detection sensor 32 or the seating detection sensor 33 finishes use of the toilet 7. In addition, the control device 100 opens the lid portion 110 when the seating detection sensor 33 detects that a user is seated on the toilet seat 5, and the control device 100 closes the lid portion 110 when the seating detection sensor 33 detects unseating of the user from the toilet seat 5. For example, the control device 100 opens the lid portion 110 when the human detection sensor 32 detects that a user enters the toilet room R, and the control device 100 closes the lid portion 110 when the human detection sensor 32 detects that the user exits the toilet room R.

Note that the opening and closing of the lid portion 110 described above is merely an example, and the control device 100 may perform opening and closing control of the lid portion 110 based on various types of information. When the human detection sensor 32 detects that a user approaches the toilet 7, the control device 100 may open the lid portion 110. For example, when it is detected that a user is present within a predetermined range (e.g., 50 cm or the like) from the toilet 7, the control device 100 may open the lid portion 110. In addition, when the human detection sensor 32 detects that a user moves away from the toilet 7, the control device 100 closes the lid portion 110. For example, when it is detected that a user is present outside the predetermined range (e. g., 50 cm or the like) from the toilet 7, the control device 100 closes the lid portion 110.

The control device 100 closes the lid portion 110 in conjunction with an instruction, issued by a user via the operation device 10, to operate the washing nozzle 6. The control device 100 closes the lid portion 110 in conjunction with operation of the washing nozzle 6. The control device 100 controls the lid portion 110 starting from an operation, performed by a user on the operation device 10, for controlling the washing nozzle 6. The control device 100 detects operation of the washing nozzle 6 (advancing of the nozzle into the bowl portion 8) and controls the lid portion 110.

The control device 100 controls the lid portion 110 such that the lid portion 110 is opened upward at the time of placement on the toilet 7. The control device 100 controls the lid portion 110 so as to bring the lid portion 110 into the closed state during operation of the washing nozzle 6. The control device 100 controls the lid portion 110 so as to bring the lid portion 110 into the closed state during operation of the washing nozzle 6 disposed at the toilet 7.

In addition, the control device 100 may control the optical sensor 34. In this case, the optical sensor 34 starts or stops detection in response to control by the control device 100. The control device 100 transmits control information for controlling start or end of detection by the optical sensor 34 to the optical sensor 34. For example, when the human detection sensor 32 or the seating detection sensor 33 detects that a user starts use of the toilet 7, the control device 100 transmits control information for causing the optical sensor 34 to start detection to the optical sensor 34. For example, when the human detection sensor 32 or the seating detection sensor 33 detects that the user finishes use of the toilet 7, the control device 100 transmits control information for causing the optical sensor 34 to end detection to the optical sensor 34.

In addition, the control device 100 may control the radio-frequency sensor 200. In this case, the radio-frequency sensor 200 starts or stops detection in response to control by the control device 100. The control device 100 transmits, to the radio-frequency sensor 200, control information for controlling start or end of detection performed by the radio-frequency sensor 200. For example, in a case where the human detection sensor 32 or the seating detection sensor 33 detects that a user starts use of the toilet 7, the control device 100 transmits, to the radio-frequency sensor 200, control information for causing the radio-frequency sensor 200 to start detection. For example, in a case where the human detection sensor 32 or the seating detection sensor 33 detects that the user finishes use of the toilet 7, the control device 100 transmits, to the radio-frequency sensor 200, control information for causing the radio-frequency sensor 200 to end detection.

In addition, the control device 100 controls the toilet lid 4 and the toilet seat 5 as illustrated in FIG. 1. The control device 100 controls the toilet lid 4 and the toilet seat 5 based on signals transmitted from the operation device 10. The control device 100 controls the toilet lid 4 based on a signal transmitted from the operation device 10, the signal indicating a control instruction relating to opening and closing of the toilet lid. The control device 100 controls the toilet seat 5 based on a signal transmitted from the operation device 10, the signal indicating a control instruction relating to opening and closing of the seating portion. The control device 100 transmits control information to the toilet lid 4 and the toilet seat 5 in a wired manner. Note that the control device 100 may transmit control information to the toilet lid 4 and the toilet seat 5 in a wireless manner.

The control device 100 determines whether the human detection sensor 32 has detected entry of a user. The control device 100 determines whether the human detection sensor 32 has detected entry of a user into the toilet room R. The control device 100 determines whether the seating detection sensor 33 has detected seating of a user. The control device 100 determines whether the seating detection sensor 33 has detected seating of a user on the toilet seat 5.

The solenoid valve 71 has a function of serving as a valve that controls a flow of a fluid by an electromagnetic method. The solenoid valve 71 switches, for example, between supply and stop of tap water from a water supply pipe. The solenoid valve 71 performs control of opening and closing in response to an instruction from the control device 100.

The nozzle motor 61 is a drive source (motor) that drives the washing nozzle 6 such that the washing nozzle 6 advances and retracts. The nozzle motor 61 performs control to advance and retract the washing nozzle 6 with respect to the main body cover 30 of the main body portion 3. The nozzle motor 61 performs control to advance and retract the washing nozzle 6 in response to an instruction from the control device 100.

The lid portion 110 can be positioned in front of the optical sensor 34 and functions as a lid. The lid portion 110 is preferably made of a non-transparent material in order to reduce the possibility that the optical sensor 34 is visible and to provide a configuration that takes user privacy into consideration. For example, the lid portion 110 may be colored so as to be formed in a non-transparent state. A surface of the lid portion 110 may be coated with a non-transparent material (paint). Note that the lid portion 110 is not limited to being non-transparent, and may be transparent. The lid portion 110 is capable of transitioning between the open state and the closed state by the actuator 111, and is positioned in front of the optical sensor 34 or causes the optical sensor 34 to be exposed.

The actuator 111 is a drive source (motor) that brings the lid portion 110 into the open state or the closed state. The actuator 111 performs control to bring the lid portion 110 into the open state or the closed state in response to an instruction from the control device 100. The actuator 111 performs control to bring the lid portion 110 into the closed state during operation of the washing nozzle 6. The actuator 111 performs control to bring the lid portion 110 into the closed state during operation of the washing nozzle 6 disposed at the toilet 7.

Although FIG. 5 illustrates a configuration in which the control device 100 and the like are included in the toilet seat device 2 as an example, the control device 100, the human detection sensor 32, the seating detection sensor 33, the optical sensor 34, and the like may be configured as devices separate from the toilet seat device 2. For example, the control device 100 may be configured as a device separate from the toilet seat device 2. For example, the control device 100 may be a server device and may be disposed at a position spaced apart from the toilet seat device 2. In this case, the control device 100 communicates with each device such as the toilet seat device 2, the human detection sensor 32, the seating detection sensor 33, and the optical sensor 34, and receives, from each of these devices, information necessary for estimation of information relating to excreta such as a urine flow rate (urine amount) or a feces amount. In addition, in this case, the toilet seat device 2 may have a configuration (such as a control circuit) for controlling various components of the toilet seat device 2 such as the nozzle motor 61, the solenoid valve 71, and the actuator 111. Note that the above is merely an example, and any device configuration can be employed for the toilet system 1 as long as desired processing can be performed.

<3-2. Functional Configuration of Radio-Frequency Sensor>Next, a functional configuration of the radio-frequency sensor 200 will be described. As illustrated in FIG. 5, the radio-frequency sensor 200 has an antenna portion 210 and a circuit portion 220.

The antenna portion 210 includes a function for transmitting and receiving radio waves. The antenna portion 210 includes a transmitting antenna 211 that emits (transmits) a predetermined radio wave, and a receiving antenna 212 that receives a radio wave.

As for the arrangement of the antenna portion 210, any arrangement can be employed. For example, the antenna portion 210 is disposed near the trap portion 82. For example, the antenna portion 210 is provided at the outer wall of the drain pipe 81 including the trap portion 82. The antenna portion 210 is provided along the outer wall of the drain pipe 81 including the trap portion 82. Alternatively, for example, the antenna portion 210 is disposed above the trap portion 82 in the vertical direction. Alternatively, for example, the antenna portion 210 is disposed above the sealing water on the trap portion 82 side in the vertical direction.

In a case where the radio-frequency sensor 200 is provided at the toilet seat device 2, for example, the antenna portion 210 is disposed on the bottom side (lower side) of the toilet seat device 2. Note that the arrangement of the antenna portion 210 described above is merely an example, and any arrangement can be employed for the arrangement of the antenna portion 210 as long as desired detection can be performed. For example, the antenna portion 210 may be disposed outside the drain pipe 81, such as on the outer wall of the drain pipe 81, or may be disposed inside the drain pipe 81, as long as desired detection can be performed.

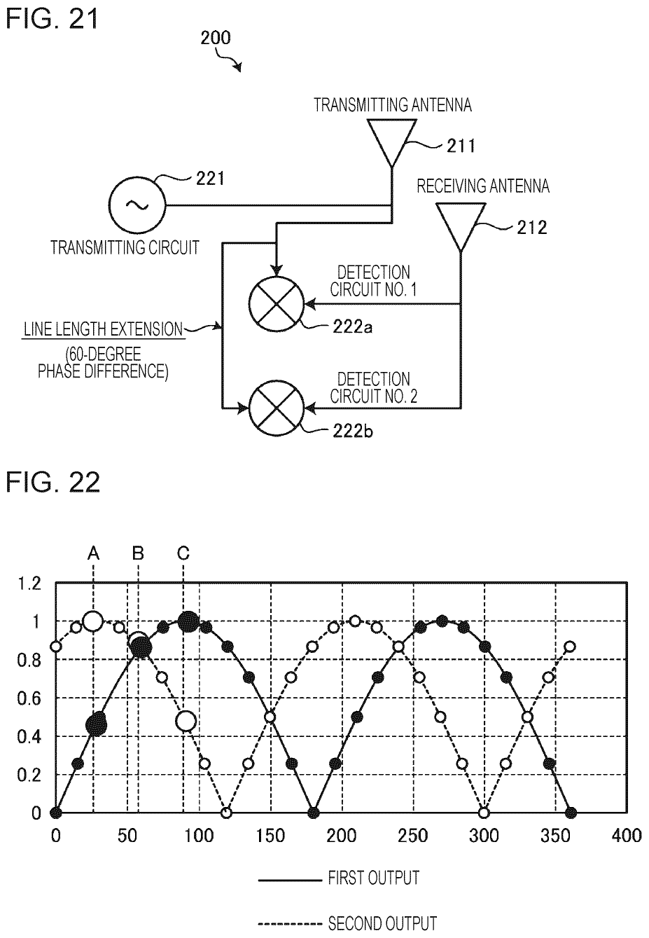

The circuit portion 220 includes a function for performing processing relating to transmission and reception of radio waves. The circuit portion 220 includes a transmitting circuit 221 that functions as an electronic circuit that generates repetitive electrical oscillation, and a detection circuit 222 that performs detection in response to reception by the receiving antenna 212. Note that the configuration illustrated in FIG. 5 is merely an example, and any configuration can be employed for the radio-frequency sensor 200. For example, a plurality of the detection circuits 222 may be included as illustrated in FIG. 21 or the like, and this matter will be described later. For example, a circuit configuration of the radio-frequency sensor 200 using one output may be a configuration including only one detection circuit 222 (e.g., a detection circuit No. 1) excluding a portion corresponding to a detection circuit No. 2 from the schematic circuit diagram illustrated in FIG. 21.

In addition, the radio-frequency sensor 200 has a function of transmitting information collected through detection to the control device 100. For example, the radio-frequency sensor 200 may be connected to the control device 100 in a wired manner and be capable of communicating information with the control device 100. Note that the radio-frequency sensor 200 may be connected to the control device 100 and be capable of communicating information with the control device 100. The radio-frequency sensor 200 may include a communication device for communicating with the control device 100.

### 4. Functional Configuration of Control Device

A functional configuration of the control device will be described below with reference to FIG. 6. FIG. 6 is a block diagram illustrating an example of the configuration of the control device according to the embodiment.

As illustrated in FIG. 6, the control device 100 includes a communication unit 101, a storage unit 120, and a control unit 130. Note that the control device 100 may include an input unit (e.g., a keyboard, a mouse, or the like) that receives various operations from an administrator of the control device 100 or the like, or a display unit (e.g., a liquid crystal display or the like) for displaying various information.

The communication unit 101 is implemented by, for example, a communication circuit or the like. The communication unit 101 is connected to a predetermined network in a wired or wireless manner, and performs transmission and reception of information with an external information processing apparatus. For example, the communication unit 101 is connected to a predetermined network in a wired or wireless manner, and performs transmission and reception of information with another device such as the operation device 10. In addition, the control device 100 may be connected to the radio-frequency sensor 200 in a wired or wireless manner by the communication unit 101, and may perform transmission and reception of information with the radio-frequency sensor 200. Note that the communication unit 101 may be configured as a separate device (communication device) from the control device 100, and the toilet seat device 2 may include the communication unit 101.

The storage unit 120 is implemented, for example, by a semiconductor memory element such as a random access memory (RAM) or a flash memory, or a storage device such as a hard disk or an optical disc. For example, the storage unit 120 is a computer-readable recording medium that non-transitorily records data and the like to be used by programs or the like for various types of information processing.

The storage unit 120 according to the embodiment stores various types of information necessary for processing. The storage unit 120 stores various types of information acquired from other devices such as various sensors. For example, the storage unit 120 stores information relating to a learning model (also simply referred to as a “model”) that is used for processing. For example, the storage unit 120 stores a model that is used for processing for estimating information relating to excreta such as a urine flow rate (urine amount) or a feces amount. For example, the storage unit 120 stores various types of information (e.g., information relating to a threshold) that is used in various types of information processing.

Returning to FIG. 6, the description will be continued. The control unit 130 is implemented, for example, as a result of a central processing unit (CPU), a graphics processing unit (GPU), or the like executing a program (e.g., a program or the like for various types of information processing according to the present disclosure) stored inside the control device 100, with RAM or the like as a work area. In addition, the control unit 130 is a controller, and is implemented, for example, by an integrated circuit such as an application-specific integrated circuit (ASIC) or a field-programmable gate array (FPGA).

As illustrated in FIG. 6, the control unit 130 includes an acquisition unit 131, a measurement unit 132, a determination unit 133, an estimation unit 134, and an output unit 135, and implements or performs information processing functions and operations that will be described below. Note that the internal configuration of the control unit 130 is not limited to the configuration illustrated in FIG. 6 and may be any other configuration as long as it is a configuration for performing information processing that will be described later.

The acquisition unit 131 acquires various types of information. The acquisition unit 131 acquires various types of information from the storage unit 120. The acquisition unit 131 receives information from another device. The acquisition unit 131 receives information (detection information and the like) detected by various sensors from these various sensors. The acquisition unit 131 receives information (detection information and the like) detected by the sensors such as the human detection sensor 32, the seating detection sensor 33, the optical sensor 34, and the radio-frequency sensor 200 from these sensors. The acquisition unit 131 acquires information that is used for processing from the storage unit 120.

The measurement unit 132 performs various types of measurement. The measurement unit 132 performs various types of measurement by using information stored in the storage unit 120. The measurement unit 132 measures a sensor value or the like detected by the radio-frequency sensor 200 by using information acquired by the radio-frequency sensor 200.

The measurement unit 132 measures information relating to a state change occurring in the sealing water on the trap portion 82 side by using information detected by the radio-frequency sensor 200. The measurement unit 132 measures, by using information detected by the radio-frequency sensor 200, information relating to a state change of the sealing water based on overflow water from the apex portion 821 of the trap portion 82.

The determination unit 133 performs determination processing. The determination unit 133 performs determination processing by using various types of information stored in the storage unit 120. The determination unit 133 performs determination processing by using various types of information acquired by the acquisition unit 131.

The determination unit 133 determines a cause of a state change of the sealing water in the toilet 7 based on a detection result obtained by the optical sensor 34. The determination unit 133 classifies state changes of the sealing water in the toilet 7 based on a detection result obtained by the optical sensor 34. The determination unit 133 determines which object a state change of the sealing water in the toilet 7 is caused by based on a detection result obtained by the optical sensor 34.

The determination unit 133 determines falling (water entry) of an object into the sealing water in the toilet 7 based on a detection result obtained by the optical sensor 34. The determination unit 133 determines an object that has entered the sealing water in the toilet 7 based on a detection result obtained by the optical sensor 34. The determination unit 133 determines excreta of a user based on a detection result obtained by the optical sensor 34.

For example, the determination unit 133 classifies a plurality of types of state changes of the sealing water including a first type of state change of the sealing water that is a state change of the sealing water due to feces, a second type of state change of the sealing water that is a state change of the sealing water due to urine, and a third type of state change of the sealing water that is a state change of the sealing water due to feces and urine. For example, the determination unit 133 classifies a state change of the sealing water that is detected by the optical sensor 34 as a state change of the sealing water due to feces, a state change of the sealing water due to urine, or a state change of the sealing water due to feces and urine.

The determination unit 133 may determine a state change of the sealing water by any method. For example, the determination unit 133 may determine a state change of the sealing water based on exceedance of a signal-level threshold or based on artificial intelligence (AI). The determination unit 133 may determine a state change of the sealing water by frequency analysis, image processing, machine learning, deep learning, or the like.

For example, the determination unit 133 determines a state change of the sealing water by using technology relating to AI. For example, the determination unit 133 may determine a state change of the sealing water by using a model generated by machine learning (also referred to as a “sealing-water state-change determination model”). In this case, the sealing-water state-change determination model is trained beforehand with training data that indicates a classification determination. This training data includes a plurality of combinations of information items (sealing-water change information items) and labels (correct information). The sealing-water change information items are, for example, images or the like and each relate to a state change of the sealing water. The labels indicate types of state changes of the sealing water that correspond to their respective sealing-water change information items. Here, the term “type” refers to an object such as, for example, feces, urine, or both feces and urine, that has caused the state change of the sealing water. For example, the training data includes a plurality of combinations of sealing-water change information items and labels (correct information). Each of the labels (correct information) indicates an object (such as, for example, feces, urine, or both feces and urine) that has entered (fallen into) the sealing water when a state change of the sealing water corresponding to the associated sealing-water change information item has occurred in the sealing water.

The sealing-water state-change determination model is a model that receives sealing-water change information as an input and outputs information that indicates a type of sealing water state change that corresponds to the sealing-water change information input thereto. For example, the sealing-water state-change determination model is trained so as to output, in a case where the sealing-water change information is input thereto, information regarding a label (a type of sealing water state change) that corresponds to the sealing-water change information input thereto. Training of the sealing-water state-change determination model is performed by appropriately using various methods relating to so-called supervised learning. In this case, the sealing-water state-change determination model is stored in the storage unit 120, and the determination unit 133 may determine a sealing water state change by using the sealing-water state-change determination model stored in the storage unit 120. For example, the control device 100 may perform training processing so as to generate the sealing-water state-change determination model. Note that the above is merely an example, and the determination unit 133 may determine a state change of the sealing water by appropriately using various information.

In addition, the determination unit 133 may determine the presence or absence of defecation (feces) based on information detected by feces detection means. The determination unit 133 may determine, by using information detected by the feces detection means such as the optical sensor 34, whether a user is excreting feces. The determination unit 133 determines the presence or absence of defecation based on an image captured by the feces detection means. Note that the above-mentioned determination of the presence or absence of defecation is merely an example, and when determining the presence or absence of defecation, the determination unit 133 may determine the presence or absence of defecation by appropriately using various information.

The estimation unit 134 performs estimation processing. For example, the estimation unit 134 performs the estimation processing based on any estimation method. For example, the estimation unit 134 performs the estimation processing by calculating information through calculation processing based on any calculation method. The estimation unit 134 performs the estimation processing by using various information stored in the storage unit 120. The estimation unit 134 performs the estimation processing by using various information acquired by the acquisition unit 131. The estimation unit 134 estimates (calculates) information relating to excreta such as a urine flow rate (urine amount) or a feces amount based on a determination result obtained by the determination unit 133.

For example, the estimation unit 134 estimates urine or feces information relating to excreta based on a detection result obtained by the radio-frequency sensor 200. The estimation unit 134 estimates a urine flow rate or a feces amount based on a state change of the sealing water. The estimation unit 134 estimates a urine flow rate based on information regarding a standing wave that is output from the radio-frequency sensor 200.

For example, the estimation unit 134 estimates information regarding urine or feces based on detection results obtained by the radio-frequency sensor 200 and the optical sensor 34. For example, the estimation unit 134 estimates information regarding urine or feces in a case where there is a correlation between a detection result obtained by the radio-frequency sensor 200 and a detection result obtained by the optical sensor 34. In a case where a detection result obtained by the optical sensor 34 indicates that excreta of a user is urine, the estimation unit 134 estimates information regarding urine based on a detection result obtained by the radio-frequency sensor 200. In a case where a detection result obtained by the optical sensor 34 indicates that excreta of a user is urine, the estimation unit 134 estimates a urine amount based on a detection result obtained by the radio-frequency sensor 200. In a case where a detection result obtained by the optical sensor 34 indicates that excreta of a user is feces, the estimation unit 134 estimates information regarding feces based on a detection result obtained by the radio-frequency sensor 200. In a case where a detection result obtained by the optical sensor 34 indicates that excreta of a user is feces, the estimation unit 134 estimates a feces amount based on a detection result obtained by the radio-frequency sensor 200.

For example, the estimation unit 134 acquires information regarding urine or feces based on detection results obtained by the radio-frequency sensor 200 and the optical sensor 34. For example, the estimation unit 134 acquires information regarding feces based on a detection result obtained by the optical sensor 34, and acquires information relating to urine or feces based on a detection result obtained by the radio-frequency sensor 200. The estimation unit 134 estimates a feces amount based on a detection result obtained by the optical sensor 34, and estimates a urine amount based on a detection result obtained by the radio-frequency sensor 200. For example, the estimation unit 134 estimates a urine amount by subtracting a feces amount estimated based on a detection result obtained by the optical sensor 34 from a total amount of excreta estimated based on a detection result obtained by the radio-frequency sensor 200.

The output unit 135 performs output processing for outputting various information. The output unit 135 functions as a transmission unit that transmits various information. The output unit 135 performs the output processing by transmitting information to an external information processing apparatus. The output unit 135 transmits information to the external information processing apparatus. For example, the output unit 135 transmits various information to an administrator device, such as a personal computer or a smartphone, that is used by an administrator. In addition, the output unit 135 may perform the output processing by transmitting information to the operation device 10 (or the screen 11).

The output unit 135 transmits information relating to excreta such as a urine flow rate (urine amount) or a feces amount estimated by the estimation unit 134. The output unit 135 transmits information indicating a urine amount estimated by the estimation unit 134. The output unit 135 outputs information indicating one of “High”, “Medium”, and “Low” each of which indicates a total urine amount (the level thereof) categorized by the estimation unit 134. The output unit 135 transmits information indicating the level of a total urine amount.

### 5. Processing Example

An example of processing based on detection performed by the radio-frequency sensor 200 will now be described below. Note that the processing described below is merely an example, and the toilet system 1 is not limited to the processing described below and may estimate a urine amount by any processing based on detection performed by the radio-frequency sensor 200.

### 5-1. Example of Processing for Estimating Information Relating to Excreta

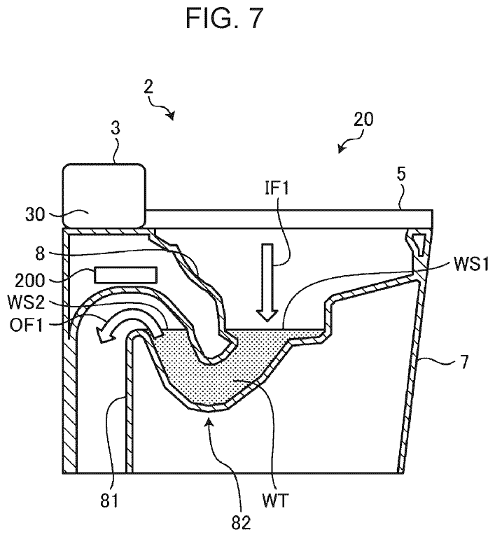

First, an overview of processing for estimating information relating to excreta based on detection performed by the radio-frequency sensor 200 will be described with reference to FIG. 7. FIG. 7 is a diagram illustrating an overview of processing for estimating information relating to excreta. Note that, in order to illustrate the overview of detection performed by the radio-frequency sensor 200, some of the reference signs and the like described in FIG. 4 (e.g., the apex portion 821, the detection range DA11, and the like) are not illustrated in FIG. 7.

In FIG. 7, the radio-frequency sensor 200 detects overflow water OF1 from the apex portion 821 of the trap portion 82. Accordingly, regarding the overflow water OF1 from the apex portion 821 of the trap portion 82 or the like, the toilet system 1 acquires trap overflow water information by using the radio-frequency sensor 200. For example, the overflow water OF1 from the apex portion 821 of the trap portion 82 illustrated in FIG. 7 occurs in response to, for example, inflow IF1 into the bowl portion 8 due to urination of a user or the like. In the toilet system 1, the radio-frequency sensor 200 performs detection relating to the overflow water OF1 from the apex portion 821 of the trap portion 82, and the toilet system 1 estimates information relating to excreta, such as a urine amount, based on the detection performed by the radio-frequency sensor 200.

As a premise, a radio-frequency sensor such as a microwave sensor or a millimeter-wave sensor passes through a ceramic or a resin but does not pass through and is reflected by water. Accordingly, the toilet system 1 detects a distance from a water surface by using the radio-frequency sensor 200 to detect waves reflected from water.

For example, in a case where a sensor is placed above a trap, when the water amount of sealing water increases due to urination, the water flows toward a drain side beyond an apex portion of the trap. When the water flows, the water level near the apex portion of the trap rises, and when detection is performed from above, the distance from the water surface decreases in response to the rise of the water level. Thus, by measuring a change in the water level from an initial value (how much the distance has decreased) by the sensor, information that is used for estimation of information relating to excreta can be obtained. In this manner, there is a correlation between a change in a water level and a urine flow rate. Therefore, by using a relationship among three types of information, which are an output of the sensor, a water level change, and a flow rate, the flow rate can be determined from the output of the sensor.

In the toilet system 1, for example, in a case where the radio-frequency sensor 200 is placed above the trap portion 82, when the water amount of the sealing water increases due to urination, water flows toward the drain side beyond the apex portion 821 of the trap portion 82. In addition, in the toilet system 1, when water flows into the drain pipe 81 in response to an increase in the water amount of the sealing water, the water level near the apex (the apex portion 821) of the trap portion 82 rises, and when detection is performed from above the trap portion 82, the distance between the radio-frequency sensor 200 and the water surface decreases in response to the rise of the water level. Therefore, in the toilet system 1, by measuring a change in the water level from an initial value (how much the distance has decreased) through detection performed by the radio-frequency sensor 200, information that is used for estimation of information relating to excreta can be obtained. In the toilet system 1, a flow rate is calculated (estimated) from the output of the radio-frequency sensor 200 by using a relationship among three types of information, which are an output of the radio-frequency sensor 200, a water level change, and a flow rate.

### 5-2. State Change Associated with Change in Flow Rate

An example of a state change associated with a change in a flow rate will now be described below. For example, a relationship between a flow rate flowing into (falling into) the sealing water from the bowl portion 8 side of the toilet 7 and a height of overflow water will be described.

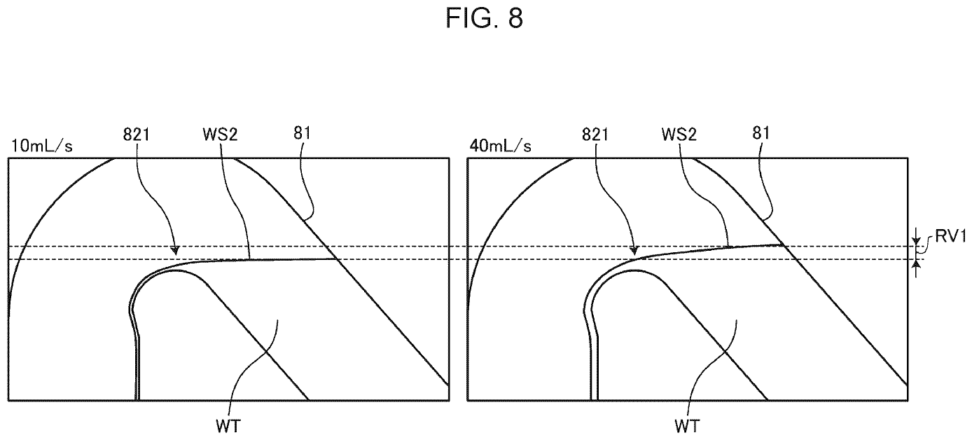

First, an overview will be described with reference to FIG. 8. FIG. 8 is a diagram illustrating an example of the relationship between a flow rate and a height of overflow water. FIG. 8 illustrates an experimental result obtained by observing a phenomenon of trap overflow water behavior that is behavior associated with a change in a flow rate when water is caused to flow in from 200 mm above the upper surface of the bowl portion 8. For example, FIG. 8 is a diagram schematically illustrating a change in the sealing water on the trap portion 82 side due to the inflow of water on the bowl portion 8 side. As illustrated in FIG. 8, the water level in the trap portion 82 changes in response to the inflow from the bowl portion 8 side into the sealing water. For example, a result was obtained in which the water level in the trap portion 82 rose by about 5 mm when the inflow rate was 40 mL/s compared with the case where the inflow rate was 10 mL/s. As described above, it was confirmed that the water level in the trap rose due to the urine flow rate. In addition, when the flow rate is changed, it is observed that movement of water flowing over the apex portion 821 of the trap portion 82 changes.

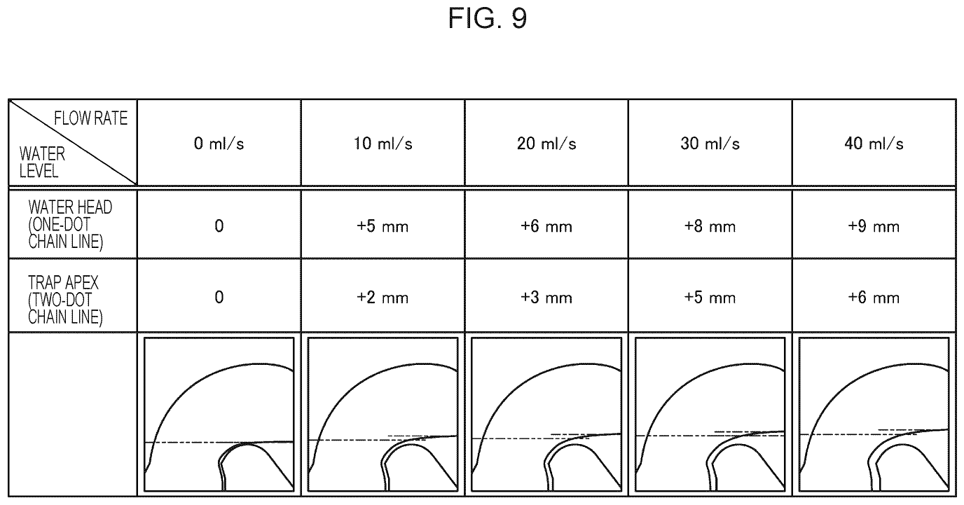

Next, a relationship between a flow rate and a water level change illustrated in FIG. 9 will be described below. FIG. 9 is a diagram illustrating an example of a state change associated with a change in the flow rate. Specifically, FIG. 9 is a diagram illustrating an example of a relationship between the flow rate and a height of each position of overflow water. The experimental results illustrated in FIG. 9 illustrate results of performing measurements of the water level change associated with a change in the flow rate using four amounts of water discharge flow rates (inflow rates), which are 10 mL/s, 20 mL/s, 30 mL/s, and 40 mL/s. For example, each column of a row corresponding to a water head (one-dot chain line) in FIG. 9 illustrates an amount of change in the water level at a water head portion due to a corresponding water discharge flow rate (inflow rate). In addition, each column of a row corresponding to a trap apex (two-dot chain line) in FIG. 9 illustrates an amount of change in the water level at a trap apex portion due to a corresponding water discharge flow rate (inflow rate). Note that 0 mL/s in FIG. 9 illustrates a state in which there is no inflow (initial state). In FIG. 9, the measurement was performed by disposing a microwave sensor on an outer wall above the trap apex (the apex portion 821).

The one-dot chain line illustrated in the drain pipe 81 corresponding to each flow rate in FIG. 9 illustrates a height of the water head. For example, the water head is a position of a tip of water (overflow water) flowing over the apex portion 821 of the trap portion 82. In addition, the two-dot chain line illustrated in the drain pipe 81 corresponding to each flow rate in FIG. 9 illustrates a height of the trap apex. For example, the trap apex is a position immediately above the apex portion 821 of the trap portion 82 among water (overflow water) flowing over the apex portion 821 of the trap portion 82. In each of the four amounts, a result was obtained in which the height of the overflow water was higher at the water head than at the trap apex. In addition, a result was obtained in which both the water head and the trap apex became higher as the inflow rate increased. As illustrated in FIG. 9, it was confirmed that the water level changed at the water head, the trap apex, and the like in response to a change in the flow rate.

### 5-3. Detection by Radio-Frequency Sensor

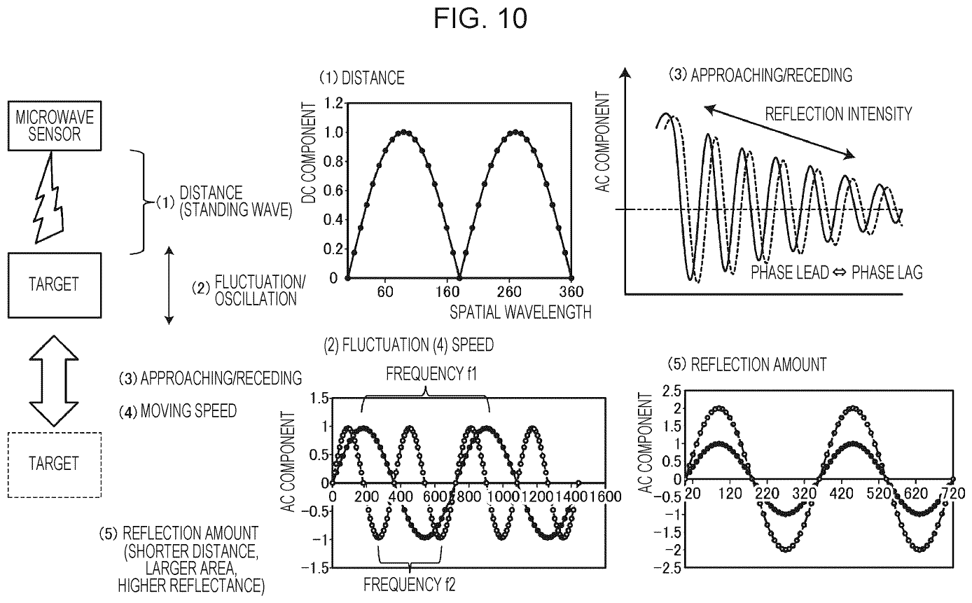

Next, information (detection information) that is obtained by detection by a radio-frequency sensor will be described with reference to FIG. 10, using a microwave sensor as an example. FIG. 10 is a diagram illustrating an example of detection information obtained by the microwave sensor.

Information (detection information) that is obtained by detection by a radio-frequency sensor such as a microwave sensor includes information such as (1) to (5) in FIG. 10. For example, as illustrated in (1) in FIG. 10, information of a standing wave that can indicate a distance between the radio-frequency sensor and a target (e.g., a water surface or the like) is obtained by detection performed by the radio-frequency sensor. Note that, in FIG. 10, the graph corresponding to (1) illustrates a relationship between a DC component corresponding to an output value of the sensor and an angle corresponding to a spatial wavelength. However, as illustrated in FIG. 12 and the subsequent drawings, the graph corresponding to (1) may be a graph illustrating a relationship between an output (value) of the sensor and a distance.

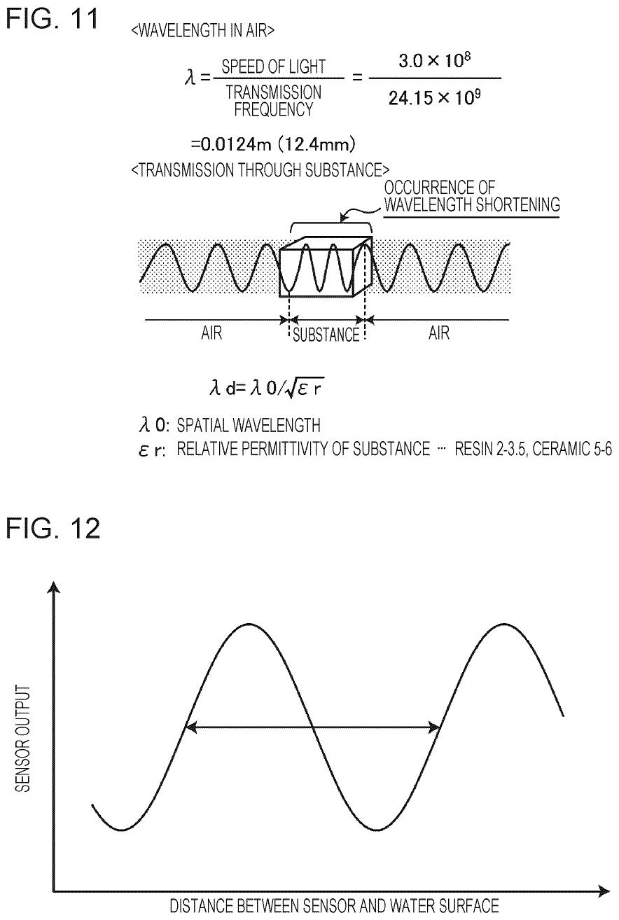

Here, an example of a feature of a standing wave will be briefly described with reference to FIG. 11. FIG. 11 is a diagram illustrating an example of a relationship between wavelengths. Specifically, FIG. 11 is a diagram illustrating an example of a relationship between a medium and a wavelength. As illustrated in FIG. 11, a wavelength λ in air (hereinafter also referred to as a “spatial wavelength λ”) is calculated by dividing the speed of light by a transmission frequency. In a case where the transmission frequency is 24.15 gigahertz (24.15×10\hat{ }9 Hz), the wavelength A in air is 0.0124 m (12.4 mm).

In addition, a wavelength Ad during transmission through a substance changes according to a relative permittivity of the substance. For example, the wavelength Ad during transmission through a substance made of a resin (e.g., the relative permittivity is 2 to 3.5 or the like) or a ceramic (e.g., the relative permittivity is 5 to 6 or the like) becomes shorter than the spatial wavelength λ, and wavelength shortening occurs. The wavelength λd is calculated by dividing the spatial wavelength λ0 by (a value of) a square root of the relative permittivity of the substance. By using the information (standing wave) regarding (1) in FIG. 10, for example, a distance between the radio-frequency sensor and an object that reflects a radio wave emitted from the radio-frequency sensor can be estimated, and this matter will be described later.

In addition, as illustrated in (2) in FIG. 10, information of fluctuation (oscillation) of a frequency or the like is obtained by the detection performed by the radio-frequency sensor. In addition, as illustrated in (3) in FIG. 10, information relating to a change in a distance, such as approaching or receding of the target, including reflection intensity or the like, is obtained by detection by the radio-frequency sensor. In addition, as illustrated in (4) in FIG. 10, information such as a moving distance of a target is obtained by detection by the radio-frequency sensor. In addition, as illustrated in (5) in FIG. 10, information such as a reflection amount or the like is obtained by detection by the radio-frequency sensor.

Among the information items (1) to (5) in FIG. 10 that are obtained by a radio-frequency sensor such as a microwave sensor, processing using distance information (standing wave) according to the spatial wavelength corresponding to (1) in FIG. 10 will be described below as an example. Note that any information item among (1) to (5) in FIG. 10, such as (2) to (5) in FIG. 10, may be used without being limited to (1) in FIG. 10. For example, in a case where information regarding the reflection amount corresponding to (5) in FIG. 10 is used, the toilet system 1 may estimate a distance between the radio-frequency sensor and a target based on a relationship in which the value of the reflection amount increases as the distance becomes shorter and an area becomes larger, and may estimate information relating to excreta such as a urine amount based on the estimated distance.

### 5-4. Example of Method for Determining Urine Flow Rate by Using Radio-Frequency Sensor

An example of a method for determining a urine flow rate by using the radio-frequency sensor 200 in the above-described toilet system 1 will now be described. First, an overview will be described with reference to FIG. 12. FIG. 12 is a diagram illustrating an example of characteristics of the radio-frequency sensor. In the graph illustrated in FIG. 12, for example, the vertical axis denotes the output (value) of the radio-frequency sensor 200, and the horizontal axis denotes the distance between the radio-frequency sensor 200 and a water surface (e.g., water (overflow water) flowing over the apex portion 821 of the trap portion 82). As illustrated in FIG. 12, the output of the sensor relates to the distance from the water surface.

In addition, as illustrated in FIG. 12, the output of the sensor becomes a sine curve, and one period of the sine curve matches the wavelength of the radio-frequency sensor. For example, in a case of a microwave having a frequency of 24 GHz, one wavelength (one period) is about 12.5 mm.

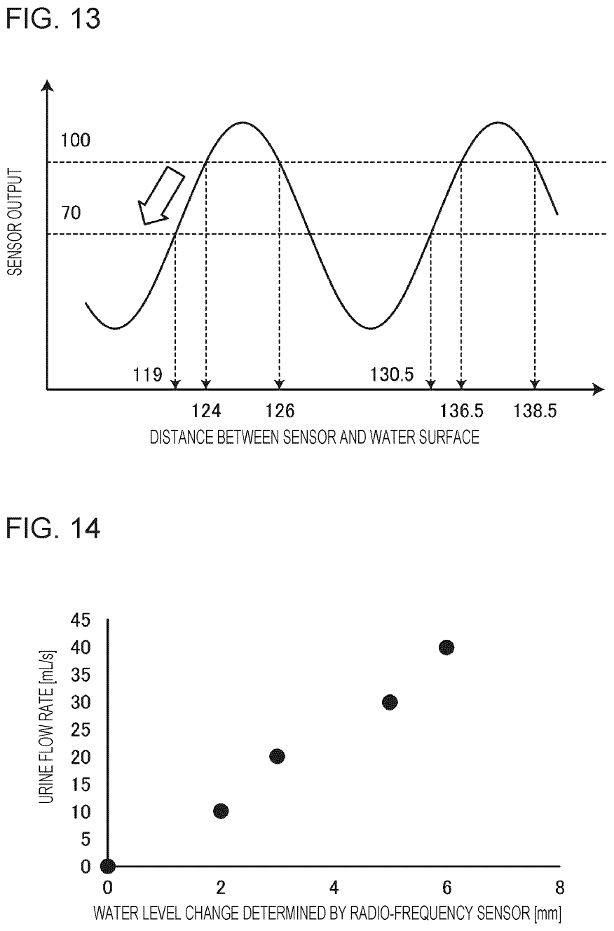

Based on the description with reference to FIG. 12 and the like, an example of processing that is performed by the toilet system 1 will now be described with reference to FIG. 13. In FIG. 13, a method for determining a water level change due to urination from one output of a sensor is illustrated. A case where an initial value of a sensor (e.g., the radio-frequency sensor 200), that is, a value before the water level changes due to urination (e.g., the output value of the radio-frequency sensor 200) is 100 will be described below as an example. Here, at a start of urination, the water surface rises, and thus, the distance between the sensor and the water surface necessarily becomes shorter due to urination. Therefore, the toilet system 1 determines the change in the water level due to urination through processing as follows. As described below, in the processing illustrated in FIG. 13, it is intended to obtain information regarding a change instead of an absolute value of the water level, and thus, information regarding a change in the value of the radio-frequency sensor 200 from an initial value to a value at the time of urination can be obtained.

In FIG. 13, based on the position of a sensor (e.g., the radio-frequency sensor 200) and the position of a trap portion (e.g., the trap portion 82) in the configuration, there are four possible values for the distance between the sensor and the water surface, that is, 124.0 mm, 126.0 mm, 136.5 mm, and 138.5 mm. For example, the toilet system 1 estimates the distance between the radio-frequency sensor 200 and the water surface to be one of 124.0 mm, 126.0 mm, 136.5 mm, and 138.5 mm based on the output of the radio-frequency sensor 200.

Then, as illustrated in FIG. 13, in a case where the output value decreases due to urination, the possible values for the distance can be narrowed down to two: 124.0 mm and 136.5 mm, which is shifted from 124.0 mm by one wavelength. For example, the toilet system 1 estimates the distance between the radio-frequency sensor 200 and the water surface to be either 124.0 mm or 136.5 mm based on the output of the radio-frequency sensor 200.

Then, as illustrated in FIG. 13, in a case where the value when the output of the sensor changes most is 70, there are two possible values for the distance: 119.0 mm and 130.5 mm, which is shifted from 119.0 mm by one wavelength. For example, the toilet system 1 estimates the distance between the radio-frequency sensor 200 and the water surface when the output of the radio-frequency sensor 200 changes most (e.g., when the distance between the radio-frequency sensor 200 and the water surface is shortest) to be either 119.0 mm or 130.5 mm based on the output of the radio-frequency sensor 200.

Then, as illustrated in FIG. 13, in either case where the distance between the radio-frequency sensor 200 and the water surface has changed from 124.0 mm to 119.0 mm or where the distance between the radio-frequency sensor 200 and the water surface has changed from 136.5 mm to 130.5 mm, the water level change is a maximum of 5.0 mm. For example, the toilet system 1 estimates the water level change due to urination to be 5.0 mm based on the output of the radio-frequency sensor 200.

As described above, in the processing illustrated in FIG. 13, it is intended to obtain a change in the water level instead of an absolute value of the water level, and thus, the change can be determined from the difference in the value of the radio-frequency sensor from the initial value to the value at the time of urination. The following three points can be listed as points in a method for determining a urine flow rate using the radio-frequency sensor 200.

As the first point regarding the fact that the water level change due to urination can be determined from the output of the radio-frequency sensor 200, at a start of urination, the water level only rises due to urination and does not decrease. Consequently, in a case where the sensor is placed above the trap, the distance between the radio-frequency sensor 200 and the water surface necessarily becomes shorter.

As the second point regarding the fact that the water level change due to urination can be determined from the output of the radio-frequency sensor 200, a urine flow rate continuously increases or decreases. However, the radio-frequency sensor 200 does not output a value far from an immediately preceding output value thereof. Consequently, based on characteristics of the first point and the second point, when a signal of the radio-frequency sensor 200 is analyzed in a time-series manner, the distance between the radio-frequency sensor 200 and the water surface can be narrowed down to a value in each wavelength interval.

As the second point regarding the fact that the water level change due to urination can be determined from the output of the radio-frequency sensor 200, it is only necessary to obtain the water level change instead of the absolute value of the water level. In addition, even if there are a plurality of distances between the radio-frequency sensor 200 and the water surface for each wavelength, the water level change is the same regardless of which distance interval is considered. Since it is intended to obtain the water level change, sufficient information can be obtained by distance measurement with the radio-frequency sensor 200.

Based on the premise described above, as illustrated in FIG. 14, the toilet system 1 can estimate an amount of inflow (e.g., a urine amount) into the bowl portion 8 from the water level change determined by the radio-frequency sensor 200. FIG. 14 is a diagram illustrating an example of processing for calculating a flow rate from a water level change. For example, the toilet system 1 estimates a urine amount from a water level change determined by the radio-frequency sensor 200 based on the relationship between flow rate and water level illustrated in FIG. 9 and based on information obtained by the detection of the water level change illustrated in FIG. 13.

In the graph illustrated in FIG. 14, for example, the vertical axis denotes urine flow rate, that is, urine amount, and the horizontal axis denotes the water level change determined by the radio-frequency sensor 200. The graph illustrated in FIG. 14 is derived from the relationship between flow rate and water level illustrated in FIG. 9. For example, the toilet system 1 determines the urine flow rate from a conversion formula or a conversion table that converts the water level change and the urine flow rate. For example, information regarding the conversion formula or the conversion table that converts the water level change and the urine flow rate may be stored in the storage unit 120 or the like.

For example, the toilet system 1 estimates a water level change through the processing illustrated in FIG. 13 or the like, and estimates a urine amount by using the estimated water level change and a conversion formula (function) that corresponds to the graph illustrated in FIG. 14. For example, the toilet system 1 estimates the water level change through the processing illustrated in FIG. 13 or the like, and estimates the urine amount using the estimated water level change and a conversion table that corresponds to the graph illustrated in FIG. 14. For example, in a case where the water level change is estimated to be 6 mm, the toilet system 1 estimates the urine amount to be, for example, 40 mL/s.

Note that the flow rate (the urine amount or the like) estimated by the toilet system 1 may be a numerical value or may be several stages (levels) of high, medium, and low. In a case where the urine amount is estimated in three stages (three levels) of high, medium, and low, the toilet system 1 may estimate the urine amount as “Low” when the estimated amount is less than 15 mL/s, may estimate the urine amount as “Medium” when the estimated amount is 15 mL/s or more and less than 30 mL/s, and may estimate the urine amount as “High” when the estimated amount is 30 mL/s or more. Note that the correspondence between ranges of the amount and stages (levels) is merely an example, and any correspondence can be employed.

### 5-5. Example of Method for Determining Total Urine Amount

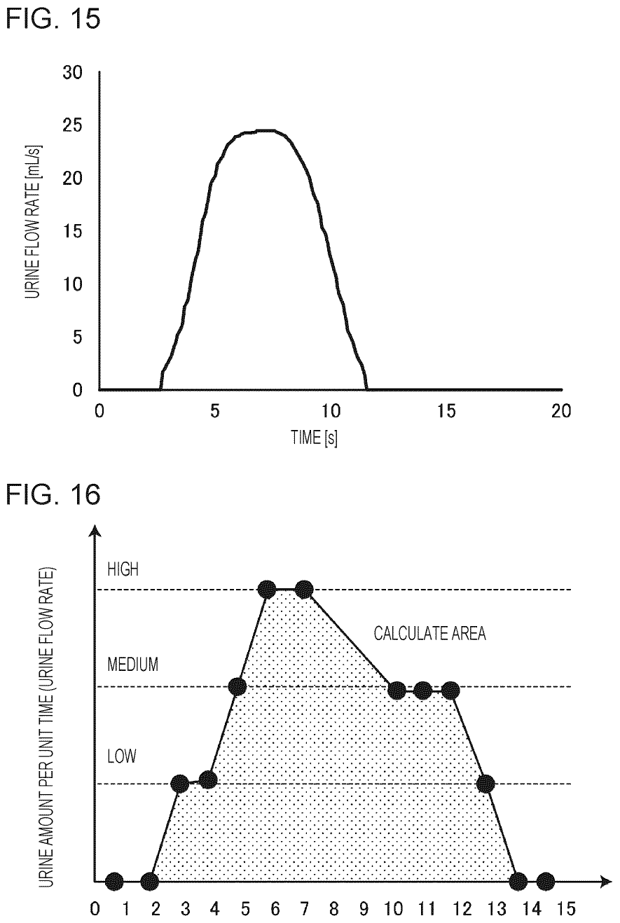

In addition, the toilet system 1 may estimate a total amount of urine (also referred to as a “total urine amount”) excreted by a user based on a urine amount estimated through the processing described above. An example in this regard will be described with reference to FIG. 15. FIG. 15 is a diagram illustrating an example of a method for calculating a flow rate. Specifically, FIG. 15 is a diagram illustrating an example of a method for estimating a total urine amount. In FIG. 15, the vertical axis denotes estimated urine flow rate (per unit time), and the horizontal axis denotes time.

For example, as illustrated in FIG. 15, the toilet system 1 measures (estimates) the urine flow rate in a time-series manner from detection performed by the radio-frequency sensor 200. Then, the toilet system 1 converts the time-series flow rate into the amount (the total amount) by integrating the time-series flow rate. For example, the toilet system 1 estimates the total urine amount by determining the area of the region (figure) formed by the waveform and the X-axis illustrated in FIG. 15. In FIG. 15, the toilet system 1 estimates the total amount of urine (the total urine amount) to be 144 mL.

In addition, the toilet system 1 may estimate a total urine amount in a similar manner also when the urine amount is estimated in several stages (levels) of “High”, “Medium”, and “Low”. An example in this regard will be described with reference to FIG. 16. FIG. 16 is a diagram illustrating an example of a method for calculating a flow rate. Specifically, FIG. 16 is a diagram illustrating an example of a method for estimating a total urine amount. In FIG. 16, the vertical axis denotes an estimated level of urine flow rate (per unit time), and the horizontal axis denotes time.

For example, as illustrated in FIG. 16, the toilet system 1 measures (estimates) the urine flow rate (level) in a time-series manner from detection performed by the radio-frequency sensor 200. Then, the toilet system 1 calculates the area of a region surrounded by the lines connecting the points and the horizontal axis, and calculates the total urine amount from the area. In FIG. 16, the toilet system 1 calculates the area of the region illustrated by hatching, and calculates the total urine amount by converting the area into a urine amount.

In this case, the toilet system 1 may have beforehand a relationship between a state change of sealing water and urine flow rate. For example, the toilet system 1 may store information indicating a correspondence relationship between each level of urine amount and a numerical value indicating a specific amount (e.g., “Low” is 10 mL/s, “Medium” is 20 mL/s, “High” is 30 mL/s, etc.) in, for example, the storage unit 120. In this case, the toilet system 1 may calculate the total urine amount to be, for example, 220 mL by converting the level at each time into a numerical value indicating a specific amount based on the information indicating the correspondence relationship between each level of urine amount and a numerical value indicating a specific amount, and by integrating the converted numerical values.

In addition, for example, the toilet system 1 may store information indicating a correspondence relationship between each level of urine amount and a numerical value corresponding to area (e.g., “Low” is 1, “Medium” is 2, “High” is 3, etc.) in, for example, the storage unit 120. In this case, the toilet system 1 calculates an area based on information indicating the correspondence relationship between each level of urine amount and a numerical value corresponding to area (e.g., “Low” is 1, “Medium” is 2, “High” is 3, etc.), by converting the level at each time into a numerical value corresponding to area, and by integrating the converted numerical values. For example, the toilet system 1 calculates an area to be 22.

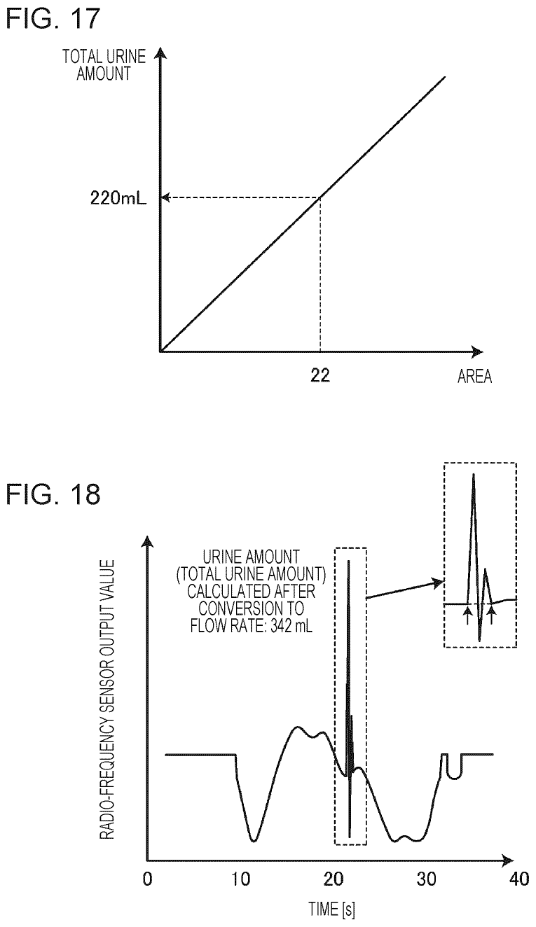

Then, the toilet system 1 calculates a total urine amount from the calculated area. For example, the toilet system 1 calculates the total urine amount by using the area and a conversion formula based on a relationship such as that illustrated in FIG. 17. FIG. 17 is a diagram illustrating an example of a relationship between area and total urine amount. For example, FIG. 17 illustrates an example of a calibration curve for calculating total urine amount from area. For example, the toilet system 1 calculates the total urine amount to be 220 mL from the calculated area “22”.

Note that the toilet system 1 may provide (display) information using any of acquired information. For example, the toilet system 1 may perform stage display such as “High”, “Medium”, and “Low”, instead of a numerical display.

### 5-6. Example of Case Where Defecation also Occurred During Urination

In addition, when defecation also occurred during urination, the toilet system 1 may perform processing for removing the influence of the defecation. For example, the toilet system 1 may perform processing such as that illustrated in FIG. 18. FIG. 18 is a diagram illustrating an example of processing in a case where defecation occurred during urination. For example, FIG. 18 illustrates an example of a method for detecting feces from an output of the radio-frequency sensor 200. In FIG. 18, the vertical axis denotes the output value of the radio-frequency sensor 200, and the horizontal axis denotes time. FIG. 18 illustrates a case where defecation occurred during urination at around 20 seconds in the graph.

As illustrated in FIG. 18, the output value of the radio-frequency sensor 200 becomes discontinuous when defecation occurs. Accordingly, the toilet system 1 performs inference (estimation) from points before and after a discontinuous point as indicated by a dotted line in the enlarged view around 20 seconds in the graph. For example, the toilet system 1 estimates the output value of the radio-frequency sensor 200 by removing the influence of feces for a time period in which the output is discontinuous, based on a line connecting a start point and an end point of the time period in which the output is discontinuous as indicated by the dotted line in the enlarged view around 20 seconds in the graph. Then, the toilet system 1 may estimate the urine amount in the time period by using the estimated output value of the radio-frequency sensor 200, and may estimate the total urine amount. In FIG. 18, the toilet system 1 calculates (estimates) the total amount of urine (the total urine amount) to be 342 mL after conversion into flow rate.

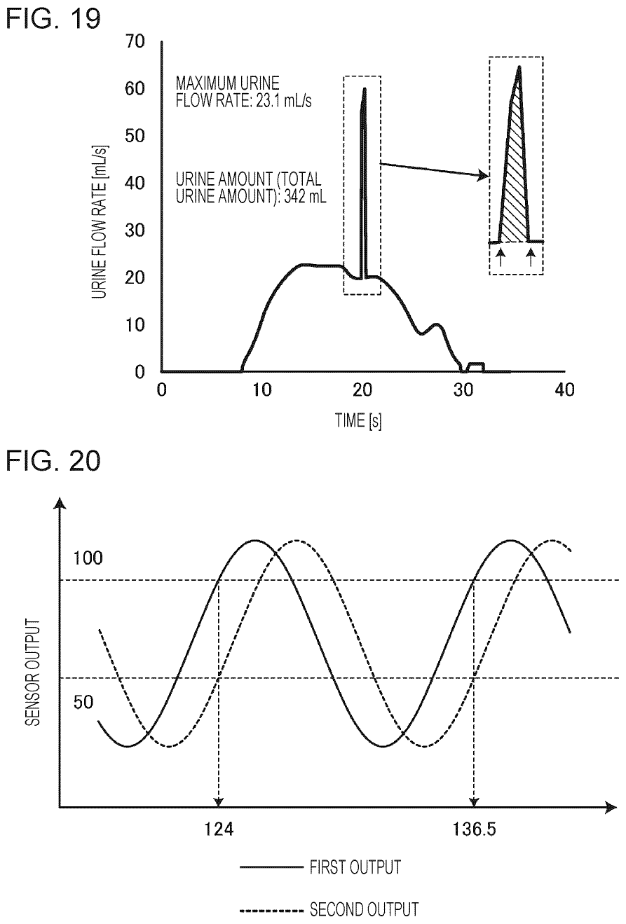

For example, the toilet system 1 may perform processing such as that illustrated in FIG. 19. FIG. 19 is a diagram illustrating an example of processing in a case where defecation occurred during urination. For example, FIG. 19 illustrates an example of a method for detecting feces after converting the output of the radio-frequency sensor 200 into flow rate. In FIG. 19, the vertical axis denotes urine flow rate, and the horizontal axis denotes time. FIG. 19 illustrates a case where defecation occurred during urination at around 20 seconds in the graph.

As illustrated in FIG. 19, a flow rate becomes discontinuous when defecation occurs. Accordingly, the toilet system 1 performs inference (estimation) from the points before and after the discontinuous point as indicated by the dotted line in the enlarged view around 20 seconds in the graph. For example, the toilet system 1 estimates that an amount corresponding to the hatched region in the enlarged view around 20 seconds in the graph is a feces amount. The toilet system 1 may calculate the feces amount from the area of the hatched region in the enlarged view around 20 seconds in the graph, and may estimate the total urine amount by subtracting (deducting) the feces amount from the total excretion amount, which is the integration of the total area. In FIG. 19, the toilet system 1 estimates the maximum urine flow rate to be 23.1 mL/s and calculates (estimates) the total amount of urine (the total urine amount) to be 342 mL.

As described above, whether the output of the radio-frequency sensor is viewed as it is or converted into water level or flow rate, the value becomes discontinuous when defecation occurs. Accordingly, when the value becomes discontinuous, the toilet system 1 deletes the value and uses the value before or after the discontinuity as it is, or averages the values before and after, to delete a signal due to feces. The toilet system 1 may integrate all including signal changes due to defecation, further calculate the feces amount by extracting only a feces signal part, and obtain the urine amount by subtracting the feces amount from the total excretion amount.

### 5-7. Case where Two Information Items with Different Phases are Used

In the above description, the case of using one output (information) has been described as an example. However, the toilet system 1 may use two information items with different phases. For example, the toilet system 1 may determine a water level change due to urination from two outputs with different phases. An example in this regard will be described with reference to FIG. 20. FIG. 20 is a diagram illustrating an example of calculation using two outputs. Note that, regarding FIG. 20, descriptions of matters similar to those in FIG. 12, FIG. 13, and the like will be omitted as appropriate.

In FIG. 20, one output (first output) is indicated by a solid line, and another output (second output) with a phase different from that of the first output is indicated by a dashed line. FIG. 20 illustrates a method for determining a water level change due to urination from two outputs of a sensor. Regarding initial values of the sensor, the case will be described below as an example in which the initial values of the first output and the second output are 100 and 50, respectively.

In FIG. 20, based on the position of the sensor and the position of the trap portion (e.g., the trap portion 82) in the configuration, there are two possible values for the distance between the sensor and the water surface, that is, 124.0 mm and 136.5 mm, which is shifted from 124.0 mm by one wavelength. For example, the toilet system 1 estimates the distance between the radio-frequency sensor 200 and the water surface to be either 124.0 mm or 136.5 mm based on the first output and the second output. The subsequent processing is the same as that in the case of one output illustrated in FIG. 13, and thus, the description will be omitted.

As described above, in a case of one output of a sensor, an initial water level is determined by measuring a water level change at an initial stage of urination in a time-series manner. However, as illustrated in FIG. 20, in a case where there are a plurality of (two) outputs, the water level can be narrowed down from these output values.

For example, when the water level drops momentarily due to seating or the like, there is a possibility that the initial water level may be incorrectly determined with one output of a sensor. However, the possibility can be reduced when there are a plurality of (two) outputs.

Note that the toilet system 1 may obtain two outputs with different phases by employing any configuration. For example, the toilet system 1 may obtain two outputs with different phases by using two radio-frequency sensors 200.

In this case, the toilet system 1 may include two radio-frequency sensors 200 including one radio-frequency sensor 200 (first radio-frequency sensor) that outputs the first output in FIG. 20 and another radio-frequency sensor 200 (second radio-frequency sensor) that outputs the second output in FIG. 20. In other words, the toilet system 1 may obtain an output from each of the two radio-frequency sensors 200.

For example, in a case of one sensor, an initial water level is determined by measuring a water level change at an initial stage of urination in a time-series manner.

However, in a case where there are a plurality of sensors, the water level can be narrowed down from output values of these sensors. For example, when the water level drops momentarily due to seating or the like, there is a possibility that the initial water level may be incorrectly determined by using one sensor. However, the possibility can be reduced when there are a plurality of sensors. Note that the toilet system 1 may use any information and may use, for example, difference information between signals of a plurality of sensors or the like.

In addition, the toilet system 1 may obtain two outputs with different phases by using one radio-frequency sensor 200. An example in this regard will be described with reference to FIG. 21. For example, the radio-frequency sensor 200 may have a configuration such as that illustrated in FIG. 21. FIG. 21 is a diagram illustrating an example of a configuration of a radio-frequency sensor. Specifically, FIG. 21 is a diagram illustrating an example of a configuration of a radio-frequency sensor for acquiring two outputs.

In a case where two outputs with different phases are obtained by using one radio-frequency sensor 200, the radio-frequency sensor 200 may have two detection circuits 222.

For example, the radio-frequency sensor 200 has the two detection circuits 222 including a detection circuit 222a illustrated as a detection circuit No. 1 in FIG. 21 and a detection circuit 222b illustrated as a detection circuit No. 2 in FIG. 21. In FIG. 21, the radio-frequency sensor 200 has a configuration in which a line length on the detection circuit 222b side is extended to be longer than a line length of the detection circuit 222a such that a phase difference of 60 degrees is obtained by the line length with respect to the transmitting circuit 221. Consequently, the detection circuit 222 b (detection circuit No. 2) is shifted from the detection circuit 222 a (detection circuit No. 1) by the line length (is delayed by 60 degrees). As a result, the toilet system 1 can estimate a distance based on a combination (relationship) between two wavelengths.

For example, as illustrated in FIG. 22, the toilet system 1 may estimate a distance by using a relationship between two outputs. FIG. 22 is a diagram illustrating an example of processing using a relationship between two outputs. In FIG. 22, an output (first output) from the detection circuit 222a is indicated by a solid line, and an output (second output) from the detection circuit 222b is indicated by a dashed line. For example, the toilet system 1 may estimate the distance between the radio-frequency sensor 200 and the water surface based on relationships, such as the relationship between the first output and the second output at A in FIG. 22, the relationship between the first output and the second output at B in FIG. 22, and the relationship between the first output and the second output at C in FIG. 22.

Note that the above-described embodiments and modifications can be appropriately combined within a range in which processing details are not inconsistent.

Further effects and modifications can be easily derived by those skilled in the art. Thus, wider aspects of the present invention are not limited to the specific details and representative embodiments represented and described above. Therefore, various changes can be made without departing from the spirit or scope of the general inventive concept defined by the appended claims and their equivalents.

The above-described embodiments and modifications may employ the following configurations, but are not limited thereto.

(1)

A toilet system comprising: a bowl portion that receives excreta; a trap portion that forms sealing water on a bottom side of the bowl portion; a radio-frequency sensor that detects a state change occurring in sealing water on the trap portion side due to the excreta falling into the sealing water; and estimation means that estimates urine or feces information relating to the excreta based on a detection result obtained by the radio-frequency sensor.

(2)

The toilet system according to (1), wherein a detection range of the radio-frequency sensor is set to a region including an apex portion of the trap portion.

(3)

The toilet system according to (1) or (2), wherein the radio-frequency sensor detects a state change of the sealing water based on overflow water from an apex portion of the trap portion.

(4)

The toilet system according to (3), wherein the estimation means estimates a urine flow rate or a feces amount based on a state change of the sealing water.

(5)

The toilet system according to (3) or (4), wherein the estimation means estimates a urine flow rate based on information regarding a standing wave that is output from the radio-frequency sensor.

(6)

The toilet system according to any one of (1) to (5), wherein the radio-frequency sensor is a millimeter-wave sensor or a microwave sensor.

(7)

The toilet system according to any one of (1) to (6), wherein a drainage passage from the bowl portion extends between the radio-frequency sensor and an apex portion of the trap portion, and wherein the radio-frequency sensor detects a state change of the sealing water based on overflow water from an apex portion of the trap portion.

(8)

The toilet system according to any one of (1) to (7), further comprising a toilet seat device installed on an upper portion of a toilet main body including the bowl portion, wherein the radio-frequency sensor is provided at the toilet seat device.

(9)

The toilet system according to (8), wherein an antenna portion that is included in the radio-frequency sensor is disposed on a bottom portion side of the toilet seat device.

(10)

The toilet system according to any one of (1) to (9), wherein an antenna portion that is included in the radio-frequency sensor is provided at an outer wall of a drain pipe including the trap portion.

(11)

The toilet system according to any one of (1) to (10), wherein an antenna portion that is included in the radio-frequency sensor is disposed above the trap portion in a vertical direction. (12)

The toilet system according to any one of (1) to (11), wherein an antenna portion that is included in the radio-frequency sensor is disposed above sealing water on the trap portion side in a vertical direction.

(13)

The toilet system according to any one of (1) to (12), further comprising an optical sensor that detects a state change of the sealing water from the bowl portion side at a plurality of timings, wherein the estimation means estimates the urine or feces information based on a detection result obtained by the radio-frequency sensor and a detection result obtained by the optical sensor.

(14)

The toilet system according to (13), wherein the estimation means estimates the urine or feces information when there is a correlation between a detection result obtained by the radio-frequency sensor and a detection result obtained by the optical sensor.

(15)

The toilet system according to any one of (1) to (14), further comprising an optical sensor that detects feces before the feces enter the sealing water from the bowl portion side, wherein the estimation means acquires the urine or feces information based on a detection result obtained by the radio-frequency sensor and a detection result obtained by the optical sensor.

(16)

The toilet system according to (15), wherein the estimation means acquires feces information based on a detection result obtained by the optical sensor and acquires the urine or feces information based on a detection result obtained by the radio-frequency sensor.

(17)

A radio-frequency device for a toilet apparatus that is installed at a toilet apparatus, the radio-frequency device comprising a radio-frequency sensor that detects a state change occurring in sealing water on a side of a trap portion that forms sealing water on a bottom side of a bowl portion, the state change being caused by excreta falling into sealing water in the bowl portion.

(18)

A method for detecting a state of a toilet system, the method comprising: a detection step of detecting a state change occurring in sealing water formed on a bottom side of a bowl portion included in the toilet system by a trap portion provided on a downstream side of the bowl portion in a drainage direction, the state change occurring in sealing water on the trap portion side due to excreta falling into sealing water on the bowl portion side.

### REFERENCE SIGNS LIST

1 toilet system
2 toilet seat device
3 main body portion (functional unit)
4 toilet lid
5 toilet seat
6 washing nozzle
7 toilet (toilet main body)
8 bowl portion
9 rim portion
20 toilet apparatus
34 optical sensor
81 drain pipe (drainage passage)
82 trap portion
100 control device (estimation means)
200 radio-frequency sensor (radio-frequency device for toilet apparatus)
210 antenna portion
220 circuit portion
R toilet room

1. A toilet system comprising:
a bowl portion that receives excreta;
a trap portion that forms sealing water on a bottom side of the bowl portion;
a radio-frequency sensor that detects a state change occurring in sealing water on the trap portion side due to the excreta falling into the sealing water; and
estimation means that estimates urine or feces information relating to the excreta based on a detection result obtained by the radio-frequency sensor.

2. The toilet system according to claim 1,
wherein a detection range of the radio-frequency sensor is set to a region including an apex portion of the trap portion.

3. The toilet system according to claim 2,
wherein the radio-frequency sensor detects a state change of the sealing water based on overflow water from the apex portion of the trap portion.

4. The toilet system according to claim 3,
wherein the estimation means estimates a urine flow rate or a feces amount based on a state change of the sealing water.

5. The toilet system according to claim 3,
wherein the estimation means estimates a urine flow rate based on information regarding a standing wave that is output from the radio-frequency sensor.

6. The toilet system according to claim 1,
wherein the radio-frequency sensor is a millimeter-wave sensor or a microwave sensor.

7. The toilet system according to claim 2,
wherein a drainage passage from the bowl portion extends between the radio-frequency sensor and an apex portion of the trap portion, and
wherein the radio-frequency sensor detects a state change of the sealing water based on overflow water from the apex portion of the trap portion.

8. The toilet system according to claim 1, further comprising:
a toilet seat device installed on an upper portion of a toilet main body including the bowl portion,
wherein the radio-frequency sensor is provided at the toilet seat device.

9. The toilet system according to claim 8,
wherein an antenna portion that is included in the radio-frequency sensor is disposed on a bottom portion side of the toilet seat device.

10. The toilet system according to claim 1,
wherein an antenna portion that is included in the radio-frequency sensor is provided at an outer wall of a drain pipe including the trap portion.

11. The toilet system according to claim 1,
wherein an antenna portion that is included in the radio-frequency sensor is disposed above the trap portion in a vertical direction.

12. The toilet system according to claim 1,
wherein an antenna portion that is included in the radio-frequency sensor is disposed above the sealing water on the trap portion side in a vertical direction.

13. The toilet system according to claim 1, further comprising:
an optical sensor that detects a state change of the sealing water from the bowl portion side at a plurality of timings,
wherein the estimation means estimates the urine or feces information based on a detection result obtained by the radio-frequency sensor and a detection result obtained by the optical sensor.

14. The toilet system according to claim 13,
wherein the estimation means estimates the urine or feces information when there is a correlation between a detection result obtained by the radio-frequency sensor and a detection result obtained by the optical sensor.

15. The toilet system according to claim 1, further comprising:
an optical sensor that detects feces before the feces enter the sealing water from the bowl portion side,
wherein the estimation means acquires the urine or feces information based on a detection result obtained by the radio-frequency sensor and a detection result obtained by the optical sensor.

16. The toilet system according to claim 15,
wherein the estimation means acquires feces information based on a detection result obtained by the optical sensor and acquires the urine or feces information based on a detection result obtained by the radio-frequency sensor.

17. A radio-frequency device for a toilet apparatus that is installed at a toilet apparatus, the radio-frequency device comprising:
a radio-frequency sensor that detects a state change occurring in sealing water on a side of a trap portion that forms sealing water on a bottom side of a bowl portion included in the toilet apparatus, the state change being caused by excreta falling into sealing water in the bowl portion.

18. A method for detecting a state of a toilet system, the method comprising:
a detection step of detecting a state change occurring in sealing water formed on a bottom side of a bowl portion included in the toilet system by a trap portion provided on a downstream side of the bowl portion in a drainage direction, the state change occurring in sealing water on the trap portion side due to excreta falling into sealing water on the bowl portion side.
